(19) United States
(12) Patent Application Publication
(10) Pub. No.: US 2026/0288859 A1
(43) Pub. Date: Sep. 24, 2026

(54) SYSTEM

(71) Applicant: SoftBank Group Corp., Tokyo (JP)

(72) Inventor: Hiroshi SHIBASAKI, Tokyo (JP)

(73) Assignee: SoftBank Group Corp., Tokyo (JP)

(21) Appl. No.: 19/568,910

(22) Filed: Mar. 17, 2026

(30) Foreign Application Priority Data
Mar. 19, 2025 (JP) 2025-045207

(51) Int. Cl. G06F 16/535; G06F 16/2457; G06F 16/56; G06F 40/40; G06T 7/00; G06T 11/60; G06V 10/25; G06V 10/764; G06V 10/82; G06V 40/16; G10L 25/63

(52) U.S. Cl. CPC G06F 16/535; G06F 16/24578; G06F 16/56; G06F 40/40; G06T 7/0002; G06T 11/60; G06V 10/25; G06V 10/764; G06V 10/82; G06T 2207/30168; G06V 40/174; G10L 25/63

(57) ABSTRACT

A system includes a processor that is configured to receive an image of a stained portion, an image of an entire object including the stain, information indicating a material of the object, information indicating circumstances under which the stain occurred, and information indicating elapsed time since the stain occurred, analyze the image of the stained portion, the image of the entire object, the material information, the stain circumstance information, and the elapsed time information by using a generative artificial intelligence model, generate, based on results of the analyzing, a prompt for instructing the generative artificial intelligence model to calculate an optimal cleaning method, search, based on the generated prompt, a database for the optimal cleaning method and select the optimal cleaning method from the database, output the selected optimal cleaning method visually by using at least one of text, diagrams, images, and videos.

### CROSS-REFERENCE TO RELATED APPLICATION

This application is based on and claims priority under 35 USC 119 from Japanese Patent Application No. 2025-045207 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional stain removal assistance systems and general cleaning guides typically provide static instructions that are not tailored to a specific stain situation of a user. In particular, such systems do not adequately take into account multiple types of input information, such as an image of a stained portion, an image of an entire object including the stain, material information, circumstances under which the stain occurred, and elapsed time since the stain occurred. As a result, the user may receive cleaning instructions that are unsuitable for the material or ineffective for the actual stain condition. Furthermore, known systems often do not leverage generative artificial intelligence models in a coordinated manner to both infer an optimal cleaning method and generate rich, multimodal guidance, such as diagrams, images, and videos, based on concrete stain conditions. In addition, conventional solutions rarely consider a user's emotional state when presenting information, and therefore may fail to provide instructions in a manner that is easy to understand and follow, especially when the user is anxious or frustrated about the stain. Accordingly, there is a need for a system that can analyze multiple types of stain-related information using a generative artificial intelligence model, determine an optimal cleaning method based on the analysis, generate appropriate prompts and content to present the method visually, and further adjust the presentation according to an emotional state of the user.

### SUMMARY

In order to solve the above-described problems, a system according to one embodiment of the present invention includes a processor configured to receive an image of a stained portion, an image of an entire object including the stain, information indicating a material of the object, information indicating circumstances under which the stain occurred, and information indicating elapsed time since the stain occurred. The processor is configured to analyze these pieces of information by using a generative artificial intelligence model and to generate, based on results of the analysis, a prompt for instructing the generative artificial intelligence model to calculate an optimal cleaning method. The processor is further configured to search, based on the generated prompt, a database for the optimal cleaning method and select the optimal cleaning method from the database. The processor is also configured to output the selected optimal cleaning method visually by using at least one of text, diagrams, images, and videos. Moreover, the processor is configured to analyze an emotional state of a user and adjust a manner of presenting information regarding the selected optimal cleaning method based on a result of the analysis of the emotional state. In some embodiments, the processor is configured to control an input unit that receives the images and the stain-related information by using an image acquisition device such as a digital camera or a smartphone, and to visually present a solution using diagrams, images, or videos generated by the generative artificial intelligence model so as to assist understanding by the user. Through these means, the system can provide stain-specific, material-appropriate, and emotionally adaptive cleaning guidance to the user.

The term “processor” refers to a hardware device or a combination of hardware and software, such as a central processing unit (CPU), microprocessor, or processing circuitry executing programs, that performs arithmetic, logic, control, and data-processing operations in order to implement the functions described in the present specification and claims. The term “generative artificial intelligence model” refers to a machine learning model, including but not limited to a neural network, that is trained on data and configured to generate outputs such as text, images, diagrams, videos, or other content, or to generate intermediate data such as prompts or parameter values, in response to input information. The term “prompt” refers to a set of instructions, parameters, or input text and associated data generated for the purpose of controlling operation of a generative artificial intelligence model, so that the generative artificial intelligence model performs a specific task such as calculating an optimal cleaning method or generating content for presentation to a user.

The term “optimal cleaning method” refers to a cleaning procedure, including one or more steps, selected as most suitable under given stain conditions, the stain conditions including at least a material of an object, a type and location of a stain, circumstances under which the stain occurred, and elapsed time since the stain occurred, and being determined based on analysis and database search as described in the present specification.

The term “image of a stained portion” refers to digital image data representing at least a localized region of an object on which a stain is present, the region being captured by an image acquisition device such as a digital camera or a smartphone.

The term “image of an entire object including the stain” refers to digital image data representing substantially the whole of the object on which the stain is present, including the stained portion and surrounding areas, captured by an image acquisition device such as a digital camera or a smartphone.

The term “material information” refers to data indicating a type, category, or composition of a material of an object on which a stain is present, for example fabric types such as cotton or wool, or solid materials such as wood, plastic, metal, or leather.

The term “stain circumstance information” refers to data describing conditions and events under which a stain occurred, including, for example, a source of the stain (such as oil, ink, or food), an action that caused the stain (such as spilling or splashing), and an environment in which the stain occurred.

The term “elapsed time information” refers to data indicating a time period that has passed since occurrence of a stain until input of the stain-related information to the system, the data being expressible in units such as minutes, hours, or days.

The term “database” refers to a logical or physical storage system that stores structured or unstructured data, including but not limited to cleaning methods, parameters related to stain and material types, media resources, and store information, and that is searchable by the processor using queries or indexing mechanisms.

The term “visually output” refers to presenting information on a display device in a visual form, including but not limited to text, diagrams, static images, animations, or videos, so that a user can perceive the information by sight.

The term “diagrams” refers to schematic visual representations, including but not limited to drawings, charts, flow diagrams, or icons, that illustrate steps, relationships, or structures related to a cleaning method.

The term “images” refers to still visual content composed of pixels or vector graphics, such as photographs, illustrations, or rendered pictures, which may depict stains, objects, tools, or cleaning procedures.

The term “videos” refers to moving-image content composed of a sequence of frames, optionally accompanied by audio, that visually depicts temporal progression of actions such as cleaning steps, tool usage, or before-and-after comparisons.

The term “emotional state of a user” refers to a psychological or affective condition of the user, such as anxiety, frustration, confidence, or satisfaction, which may be inferred from user interaction, facial expressions, voice characteristics, physiological signals, or other observable indicators.

The term “manner of presenting information” refers to one or more attributes of how information is displayed or communicated to the user, including layout, amount of detail, choice of media types, sequence and timing of presentation, tone of explanatory text, and use of emphasis or highlights.

The term “image acquisition device” refers to a device capable of capturing an image as digital data, including but not limited to a digital camera, a smartphone, a tablet, or a webcam, used to obtain images of a stained portion and an entire object including the stain.

The term “input unit” refers to hardware and software components that receive user input or sensor input, including components configured to accept image data, material information, stain circumstance information, and elapsed time information, and to provide the received data to the processor.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

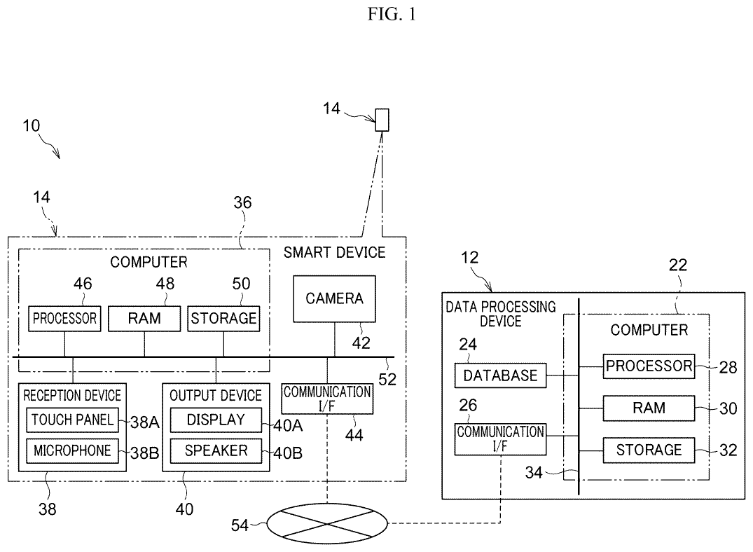

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

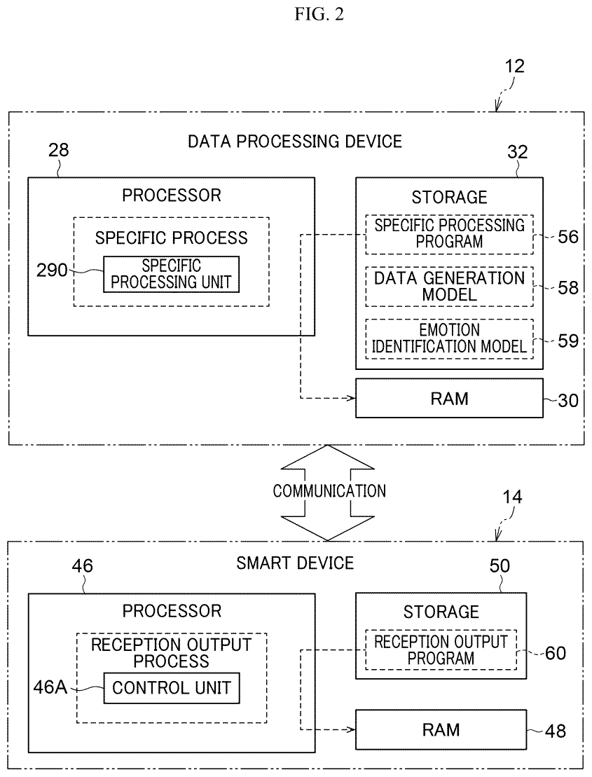

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for providing cleaning guidance based on stain images primarily focus on simple rule-based matching between a coarse stain type and a material type. Such systems typically retrieve a pre-authored static instruction set from a storage unit and present it to a user in a fixed format. These approaches suffer from several technical limitations in the context of modern information processing environments.

First, conventional systems are not configured to generate or use rich, structured feature data derived from combined analysis of multi-view image data, contextual metadata, and time-dependent parameters. As a result, such systems cannot accurately characterize stain conditions (for example, degree of penetration, severity, or sensitivity to cleaning strength) at the level of granularity needed to optimize downstream computational processes such as database retrieval and content generation. This leads to suboptimal query formation for a storage unit, inefficient use of computing resources, and limited adaptability of the system to diverse stain and material conditions.

Second, conventional systems do not integrate image analysis outputs with a generative AI model in a manner that leverages structured cleaning-method information as a control signal for natural language generation. In many cases, a generative AI model, if used at all, is prompted with loosely structured textual descriptions. This can cause the model to generate inconsistent, hallucinated, or technically inappropriate cleaning instructions, thereby reducing reliability of the system and requiring additional post-processing or human intervention. From a computer-technology perspective, the inability to systematically transform low-level image features and contextual data into a constrained, machine-readable representation for prompting a generative AI model results in inefficient and unstable utilization of model inference resources.

Third, conventional output mechanisms largely ignore inferred user state when configuring how information is presented. Presentation logic is usually static, regardless of user emotional state or interaction patterns. This means that the system cannot adapt the detail level, order, or style of explanations to the user's current cognitive load or frustration level. Technically, this lack of feedback control limits the effectiveness of the human-computer interface and can lead to repeated requests, unnecessary server round-trips, and inefficient use of network and processing resources.

Fourth, in many existing solutions, image acquisition, user input collection, server-side analysis, and content generation are not integrated into a coherent, end-to-end processing pipeline. Data flows between client devices and servers are often ad-hoc, with unstructured payloads that require redundant parsing and transformation. This increases computational overhead and complicates scaling and maintenance, thereby degrading the overall performance and robustness of the system.

Therefore, there is a need for an improved computer-implemented system that: (i) systematically structures multi-source input data into feature quantities suitable for precise database querying; (ii) generates controlled prompt sentences for a generative AI model based on structured cleaning-method information; (iii) dynamically adjusts generation and presentation parameters according to an estimated user emotional state; and (iv) integrates these capabilities into a unified processing architecture to improve accuracy, efficiency, and stability of providing cleaning guidance.

The specific processing by the specific processing unit 290 of the data processing device 12 in Example 1 is realized by the following means.

The present invention provides a server comprising a processor configured to acquire, from at least one terminal device, first image data including a soiled region, second image data including an entire object including the soiled region, material information, soil occurrence information, and elapsed-time information, to convert the acquired data into structured input data, and to execute image analysis processing on the structured input data to estimate a soil type, a soil region, and soil characteristics, to combine the soil characteristics with the material information and the elapsed-time information to generate a feature quantity, and to generate, based on the feature quantity, a search condition for retrieving cleaning-method information defining cleaning conditions and a cleaning procedure, the processor being further configured to perform an inquiry process to an information storage unit using the search condition to obtain a plurality of candidate cleaning-method information items, to evaluate the plurality of candidate cleaning-method information items based on at least material protection, cleaning effectiveness, and workability, and to select an optimal candidate cleaning-method information item, to decompose the selected optimal candidate cleaning-method information item into elements to generate structured cleaning information including tool information, detergent information, liquid-condition information, procedure information, and caution information, to generate a prompt sentence for a generative AI model based on the structured cleaning information so as to instruct generation of an explanatory text describing an analysis result including the structured cleaning information, to provide the prompt sentence to the generative AI model to cause the generative AI model to generate the explanatory text in natural language, to generate presentation output data by combining the explanatory text and the structured cleaning information such that document information, graphic information, image information, and video information are included, and to transmit the presentation output data to the terminal device, and to estimate a user emotional state based on user operation information or sensor information received from the terminal device and dynamically adjust at least one of content of the prompt sentence and a configuration of the presentation output data such that at least one of a detail level, an expression style, and a presentation order of the explanatory text is changed according to the user emotional state. This enables the server to implement an integrated, computer-implemented pipeline that (i) transforms heterogeneous sensor and user-input data into feature quantities optimized for database retrieval, (ii) constrains and guides a generative AI model through structured prompt sentences derived from machine-readable cleaning-method information so as to obtain consistent and reliable explanatory text, and (iii) adaptively controls the level and style of generated and presented content based on an inferred user emotional state, thereby improving computational efficiency, stability, and user comprehension in providing stain-specific cleaning guidance.

The term “system” refers to an arrangement of one or more information processing devices, storage devices, and communication devices configured to execute the processing operations described in the claims.

The term “processor” refers to one or more hardware processing units, such as a central processing unit or a graphics processing unit, configured to execute instructions of a program to perform computational operations.

The term “terminal device” refers to a user-operated electronic device having a display function and an input function, such as a portable communication device, a general-purpose computing device, or an image acquisition device.

The term “information storage unit” refers to a logical or physical storage component, such as a memory device or a storage device, configured to store cleaning-method information and other data in a readable and writable manner.

The term “first image data” refers to digital image data that includes at least a soiled region of an object and is acquired by an image acquisition device.

The term “second image data” refers to digital image data that includes an entirety or a wide region of an object including the soiled region and is acquired by an image acquisition device.

The term “soiled region” refers to a portion of an object in which a foreign substance or contamination is present and is to be removed by a cleaning operation.

The term “material information” refers to information indicating a category or type of base material of an object to which a soiled region belongs, such as textile, metal, plastic, or glass.

The term “soil occurrence information” refers to information indicating a cause, source, environment, or situation in which a soiled region was generated, such as spilled liquid, adhered oil, or dried mud.

The term “elapsed-time information” refers to information indicating a time period from an occurrence of a soiled region to a time of data acquisition or analysis.

The term “structured input data” refers to data in which the first image data, the second image data, the material information, the soil occurrence information, and the elapsed-time information are represented in a predefined machine-readable format with explicit fields and relationships.

The term “image analysis processing” refers to computational operations performed on image data to extract features or attributes, including but not limited to classification, detection, or segmentation.

The term “soil type” refers to a category or classification assigned to a soiled region based on its visual or physical characteristics, such as liquid stain, pigment stain, or oil-based stain.

The term “soil characteristics” refers to one or more attributes of a soiled region, such as color, size, distribution, penetration degree, viscosity, or adhesion strength.

The term “feature quantity” refers to a numerical or symbolic representation generated from soil characteristics, material information, and elapsed-time information and used as an input for search, inference, or classification processing.

The term “search condition” refers to one or more parameters, constraints, or criteria derived from a feature quantity and used to retrieve cleaning-method information from an information storage unit.

The term “cleaning-method information” refers to information defining one or more cleaning conditions, tools, agents, and procedures for removing a soiled region from an object.

The term “cleaning conditions” refers to operational parameters used in a cleaning process, such as type and amount of cleaning agent, temperature of liquid, application pressure, and cleaning duration.

The term “cleaning procedure” refers to an ordered sequence of actions or steps to be performed to remove a soiled region using specified tools and agents.

The term “candidate cleaning-method information item” refers to an instance of cleaning-method information retrieved from an information storage unit based on a search condition and being subject to evaluation and selection.

The term “structured cleaning information” refers to cleaning-related information expressed in a machine-readable format with defined elements, including tool information, detergent information, liquid-condition information, procedure information, and caution information.

The term “tool information” refers to information specifying instruments or implements used during a cleaning procedure, such as cloths, brushes, or containers.

The term “detergent information” refers to information specifying types or properties of cleaning agents, such as detergents, solvents, or stain removers, to be used in a cleaning procedure.

The term “liquid-condition information” refers to information specifying conditions of a liquid used in a cleaning procedure, including but not limited to temperature, quantity, and application method.

The term “procedure information” refers to information describing each step of a cleaning procedure, including order, repetition, and conditional execution of actions.

The term “caution information” refers to information describing constraints, warnings, or precautions to be observed during a cleaning procedure to avoid damage or adverse effects.

The term “prompt sentence” refers to text data constructed to instruct a generative AI model to generate an output, the text data including structured content derived from analysis results and cleaning-method information.

The term “generative AI model” refers to a machine-learned model configured to generate natural-language text or other content in response to an input prompt, based on parameters trained on data.

The term “explanatory text” refers to natural-language text generated by a generative AI model based on a prompt sentence and configured to explain an analysis result and a cleaning method to a user.

The term “presentation output data” refers to data for presentation including one or more of document information, graphic information, image information, and video information, generated for transmission to and display on a terminal device.

The term “document information” refers to textual content including explanatory text, lists, or other written descriptions presented to a user.

The term “graphic information” refers to non-photographic visual data such as diagrams, icons, flow charts, or illustrations that visually represent a cleaning method or related information.

The term “image information” refers to photographic or rasterized visual data, including still images depicting objects, soiled regions, or cleaning steps.

The term “video information” refers to time-series visual data including moving images that depict cleaning operations or changes in a soiled region over time.

The term “user operation information” refers to information indicating user interactions with a terminal device, such as touch inputs, button presses, scroll operations, or navigation actions.

The term “sensor information” refers to data obtained from one or more sensors associated with a terminal device, such as motion sensors, microphones, cameras, or biometric sensors.

The term “user emotional state” refers to an estimated internal state of a user, such as confusion, satisfaction, frustration, or confidence, inferred from user operation information, sensor information, or a combination thereof.

The term “expression style” refers to characteristics of generated or presented text, including tone, formality, directness, sentence length, and use of technical terminology.

The term “presentation order” refers to a sequence in which elements of presentation output data, such as explanatory text sections, images, and videos, are arranged and displayed to a user.

The term “portable terminal device” refers to a movable user-operated computing device having at least a communication function, a display function, and an input function, such as a handheld communication terminal or a tablet-type terminal.

The term “image acquisition device” refers to a device having an imaging function configured to capture image data of an object and output the image data to another device or storage.

The term “user interface control program” refers to software executed on a terminal device or an image acquisition device to control display of input screens, reception of user inputs, and transmission of acquired data.

The term “continuous or stepwise display” refers to a mode of presentation in which graphic information, image information, and video information are displayed either sequentially in time or in discrete stages corresponding to steps of a cleaning procedure.

In one embodiment, the invention is implemented by a server, one or more terminals, and a communication network connecting them. The server includes at least one hardware processor such as a central processing unit and optionally a graphics processing unit, a main memory such as a random-access memory, a non-volatile storage device such as a solid-state drive, and a network interface. The terminal includes a hardware processor, a memory, a display panel, an input device such as a touch panel, and an image acquisition device such as a digital camera.

The server executes a server-side program implemented, for example, using an operating system such as a general-purpose server operating system, a web application framework such as a server-side framework, an image processing library such as an image analysis library, and a machine learning framework such as a deep learning library. The terminal executes a client-side application implemented, for example, as a mobile application using a mobile platform software development kit.

The terminal acquires a first image including a soiled region and a second image including an entire object including the soiled region by controlling the built-in camera. The terminal performs basic preprocessing such as resolution selection and compression and stores these images as digital image data in a memory. The terminal further acquires material information, soil occurrence information, and elapsed-time information via a graphical user interface. The terminal stores these pieces of information in a structured record having predefined fields, and the terminal transmits the record and the images to the server via a network protocol such as HTTPS.

The server receives these data via the network interface and stores the raw images in a storage area. The server then loads the images into an image processing module implemented using the image analysis library. The server converts color spaces, resizes the images to a predetermined resolution, and normalizes pixel values, thereby generating tensor data suitable for neural network input. The server uses a convolutional neural network implemented using the deep learning library as an image classifier and segmentor. In one example, the server uses a convolutional neural network including multiple convolution layers, pooling layers, rectified linear unit activation layers, and fully connected layers. The server configures this network to output both a probability distribution over possible soil categories and a segmentation mask indicating pixel-level probability that a pixel belongs to a soiled region.

The server trains this convolutional neural network in advance using a large training dataset including pairs of image data and ground-truth labels indicating soil categories and segmentation masks. The server minimizes a loss function including a cross-entropy term for classification error and a segmentation loss term, for example, a Dice loss or an intersection-over-union loss. The server updates network weights by gradient-based optimization such as stochastic gradient descent with momentum or an adaptive optimization algorithm. The server applies data augmentation techniques such as random rotation, cropping, and brightness adjustment during training to improve generalization.

The server, during inference in the deployed system, applies the trained convolutional neural network to the first image and optionally to the second image. The server generates a target soil category, a segmentation mask, and derived soil characteristics such as estimated size of the soiled region, average color values, and texture descriptors. The server stores these values as a structured feature set in the memory. The server then combines these image-derived features with the material information, soil occurrence information, and elapsed-time information into a feature vector including numerical and categorical components. The server encodes categorical values as one-hot vectors or embeddings and normalizes numerical values.

The server applies an inference model such as a gradient boosting decision tree or a feedforward neural network to this feature vector to estimate additional attributes, for example, penetration degree, severity level, and recommended cleaning intensity. The server trains this inference model in advance using supervised learning with a loss function such as mean squared error or cross-entropy, depending on whether the labels are continuous or discrete. The server uses these inferred attributes to form a feature quantity that more precisely characterizes the cleaning context than simple soil type and material alone. The server converts this feature quantity into database query parameters. The server generates a query including constraints on soil type, material category, elapsed time category, severity level, and cleaning intensity. The server then executes the query against a relational or document-oriented database storing cleaning-method information. The database stores each cleaning method as a record including fields for applicable soil types, applicable materials, required tools, required detergents, liquid use conditions, ordered steps, and caution conditions. The server retrieves multiple candidate cleaning methods and calculates a score for each candidate based on a scoring algorithm implemented in software. The server combines multiple criteria such as match degree between feature quantity and method applicability ranges, estimated safety margin for the material, expected cleaning effectiveness, and complexity of required tools into a weighted sum. The server selects the candidate method with the highest score.

The server then decomposes the selected cleaning-method record into a structured cleaning information object. The server stores tool information, detergent information, liquid-condition information, procedure information, and caution information in a hierarchical data structure, such as an object having nested lists for sequential steps and linked metadata for each step. This decomposition enables the server to manipulate and reconfigure the content algorithmically, rather than presenting static text.

The server constructs a prompt sentence for a generative AI model based on this structured cleaning information. The server generates a textual instruction that explicitly enumerates the steps, tools, detergents, and conditions in a machine-readable but natural-language form, and that constrains the generative AI model to remain within the selected method. For example, the server may generate the following prompt sentence:

“The user has an item made of delicate fabric with a red wine stain that occurred 15 minutes ago. The analyzed soil type is red wine, the material is delicate fabric, and the recommended cleaning method is as follows: (1) gently dab the stained area with cold water using a clean white cloth, (2) apply a small amount of fabric-specific detergent to the stained area, (3) rinse carefully with cold water, and (4) air-dry the item away from direct sunlight. Please explain this cleaning method in clear, step-by-step instructions suitable for a non-expert. Include a short introduction, a numbered procedure, a list of required tools and detergents, and safety precautions. Avoid adding steps or materials that are not in the recommended method.” The server uses a generative AI model implemented as a transformer-based neural network trained on large-scale text data to generate natural-language text from such a prompt sentence. In one example, the server uses a transformer architecture including multi-head self-attention layers, feedforward layers, and positional encodings. The server trains or fine-tunes the model such that domain-specific vocabulary regarding cleaning procedures is accurately handled. The server defines a training objective such as minimizing negative log-likelihood of target text tokens given input prompts, and uses gradient-based optimization with regularization techniques such as dropout.

The server, at inference time, sets decoding parameters such as temperature, top-k or top-p sampling, and maximum token length to control the style and determinism of generated text. The server evaluates the output to ensure consistency with the structured cleaning information by comparing extracted entities such as mentioned tools and detergents to the structured data. If the server detects inconsistencies, the server discards or modifies the generated segments accordingly. By constraining the generative AI model with structured input and post-generation validation, the server reduces hallucinated content and improves the reliability of the generated explanation.

The server additionally collects user operation information and sensor information from the terminal. The terminal records, for example, scrolling speed, repeated viewing of certain steps, and duration of focus on particular parts of the explanation. The terminal may also provide information from sensors such as accelerometers, microphones, or cameras, to the extent permitted. The server uses these time-series data as input to a user-state estimation model implemented, for instance, as a recurrent neural network or a temporal convolutional network. The server trains this model to output an estimated emotional state class, such as confused, calm, or frustrated, using labeled training data. The server uses a classification loss such as cross-entropy and evaluates performance metrics such as accuracy and F1 score. The server, based on the estimated emotional state, dynamically adjusts both the prompt sentence supplied to the generative AI model and the configuration of the presentation output data. For a user estimated to be confused, the server modifies the prompt sentence to request more detailed, step-by-step explanations and additional examples. For a user estimated to be experienced or calm, the server modifies the prompt sentence to request concise instructions. This dynamic prompt adaptation changes the output of the generative AI model in a manner tuned to user state. Additionally, the server changes the presentation order, for example, by prioritizing caution information or by showing short summary steps first, followed by detailed expansions. This adjustment is performed by reordering or filtering elements in the structured cleaning information object.

The server then constructs presentation output data. The server composes an output package including text segments produced by the generative AI model, machine-derived summaries, and media references. The server selects images and videos from a media database based on the selected cleaning method and associates them with respective procedure steps. The server may generate diagrams dynamically using vector-graphics routines that illustrate motions such as dabbing versus rubbing. The server compresses the presentation output data and transmits it to the terminal via the network.

The terminal receives the presentation output data and parses the structured representation. The terminal maps textual fields to text views, image fields to image views, and video references to media player components. The terminal displays the explanation in a multi-panel layout, in which the user can scroll through numbered steps and tap each step to see associated images or videos. The terminal uses local rendering libraries to draw diagrams and play videos, thereby controlling actual hardware display and audio output. The terminal can cache the received data in local storage, thereby reducing subsequent communication load when the user returns to the same instruction set.

The user reads the instructions, prepares the tools and detergents indicated in the tool information and detergent information, and executes physical cleaning actions on the real-world object. The user interacts with the terminal during cleaning, for example, by pausing videos, zooming into illustrations, or returning to safety warnings. The terminal sends these interactions back to the server as user operation information, forming a feedback loop which the server uses to further refine emotional-state estimation and presentation adaptation. This architecture yields technical effects that go beyond mere automation of human advice-giving. The server uses feature quantities derived from deep image analysis and contextual metadata to narrow the set of candidate cleaning methods in the database. This reduces database query space and minimizes retrieval time compared to naive key-word or rule-based searches. The structured cleaning information format enables efficient computation of scores and reconfiguration of content without repeated parsing of unstructured natural-language records, thereby improving processing speed and reducing memory overhead.

Furthermore, the use of structured prompt sentences based on machine-readable cleaning-method information improves the determinism and reliability of the generative AI output. Because the server constrains the generative AI model to operate within a predefined set of tools, steps, and conditions, the generated text is less likely to contain extraneous or unsafe instructions. This reduces the need for additional manual review and lowers the risk of errors. The server also reduces overall network load and processing time by reusing previously computed structured cleaning information and adjusting only the prompt sentence and presentation layout when the user emotional state changes, thereby avoiding repeated full analysis.

The described use of neural network architectures and inference models is not simply a replacement of human decision-making but an improvement to computer functionality itself. The server implements advanced feature extraction and structured data generation that allow more efficient memory access patterns and cache utilization when retrieving and ranking cleaning methods. The modular design of the image analysis, feature construction, database retrieval, generative AI interaction, and user state adaptation modules enables parallelization across multiple processing units, further enhancing throughput.

Alternative embodiments are also possible. In another embodiment, the server uses a different neural network architecture, such as a vision transformer, for image analysis instead of a convolutional neural network. In another embodiment, the server uses a rule-based engine in combination with a machine learning model to determine cleaning intensity levels, where rules serve as safety constraints and the machine learning model refines border-line decisions. In another embodiment, the server performs some preprocessing steps, such as image resizing and feature extraction, on the terminal to reduce uplink bandwidth usage, and transmits compressed feature vectors instead of full-resolution images.

In another variation, the terminal provides an interface that allows the user to request alternative prompt styles, such as “very brief summary,” “detailed explanation for beginners,” or “technical explanation.” The server translates these user preferences into parameters that modify the prompt sentence, thereby adjusting generative AI behavior in a controlled manner. This approach allows flexible but computationally stable variation in generated text without changing the underlying cleaning-method data.

The system can also be extended to additional types of contamination or materials by augmenting the training data and cleaning-method database. In such cases, the server retrains or fine-tunes the neural networks with new labeled data and expands the structured information schema to accommodate new attributes. This extensible architecture maintains the technical advantages of efficient search, constrained generation, and adaptive presentation, while accommodating new use-cases.

By integrating these components-image-based feature extraction, contextual feature construction, structured database retrieval, controlled generative AI prompting, and user state adaptive presentation the server, the terminal, and the network collectively provide a technical solution that improves computer performance and reliability in generating and delivering personalized cleaning guidance. The system reduces computational complexity in search, improves accuracy and consistency of generated explanations, and lowers communication and processing overhead through structured data handling and adaptive control.

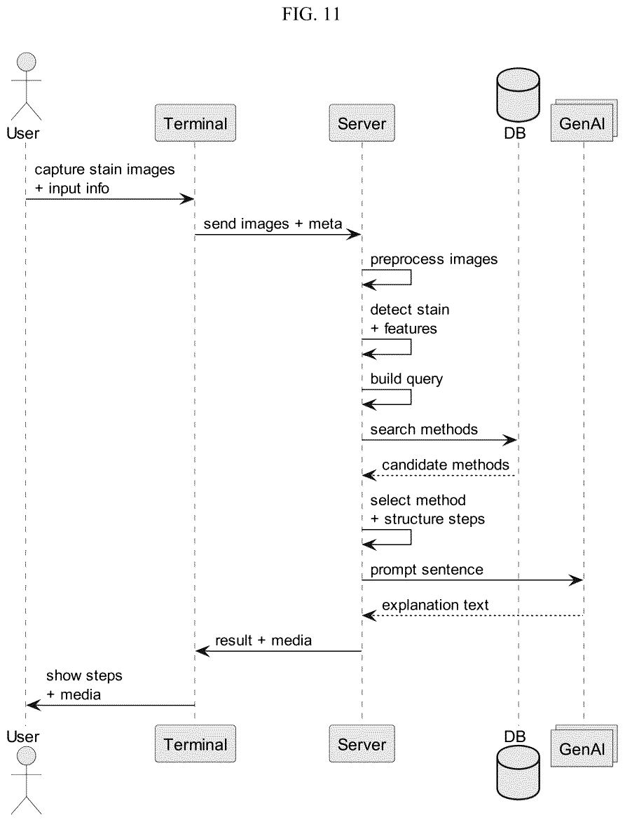

The following describes the processing flow using FIG. 11.

### Step 1:

The user operates the terminal to acquire input data.

The user positions an object having a soiled region in front of the terminal's camera and triggers an image capture operation via a graphical user interface. The terminal controls the camera hardware to capture a first image focusing on the soiled region and a second image including the entire object. The terminal then displays input fields or selectable options for material information, soil occurrence information, and elapsed-time information. The user enters or selects values such as “delicate fabric,” “spilled red liquid,” and “15 minutes ago.” Input: Scene including a soiled object and user-provided contextual information.

Operation: The terminal converts the captured optical information into digital image data (for example, RGB pixel arrays) and stores the textual inputs as character strings associated with predefined keys. The terminal may compress the images and normalize character encodings.

Output: First image data, second image data, material information, soil occurrence information, and elapsed-time information stored in the terminal's memory.

### Step 2:

The terminal structures and transmits the input data.

The terminal assembles the first image data, the second image data, the material information, the soil occurrence information, and the elapsed-time information into a structured data object, for example, with fields such as “closeup_image,” “overall_image,” “material,” “soil_cause,” and “elapsed_time.” The terminal encodes this object in a machine-readable format and prepares a communication request to the server over a secure network connection.

Input: First image data, second image data, and contextual information stored in the terminal.

Operation: The terminal creates a structured representation (for example, a key-value map), encodes binary image data into a transmission-friendly format, and attaches headers such as content type and authentication tokens. The terminal then transmits the request via a protocol such as HTTPS to a designated server endpoint.

Output: A network message containing structured input data delivered to the server.

### Step 3:

The server receives and preliminarily validates the structured input data.

The server accepts the network message via a network interface and passes it to a server application. The server parses the headers and body to extract the structured object that includes the images and associated metadata. The server checks that required fields are present, image sizes are within allowed limits, and data formats match expected types.

Input: Structured request from the terminal containing images and contextual fields.

Operation: The server performs syntactic validation (for example, type checks and presence checks) and may perform simple semantic checks (for example, elapsed time must be non-negative). The server then stores the raw image data in a storage area and loads the metadata into an in-memory data structure for further processing.

Output: Validated image data stored on the server and a validated metadata object in the server memory.

### Step 4:

The server preprocesses the image data for analysis.

The server loads the stored first and second images into an image processing module. The server resizes each image to a target resolution, converts the color space to a unified format, and normalizes pixel values into a numeric range suitable for neural network input.

Input: Raw first image data and raw second image data stored on the server.

Operation: The server applies image operations such as resizing, cropping, and color normalization. These operations are implemented as array transformations that change pixel dimensions and pixel value ranges. The server outputs multidimensional numeric arrays (tensors) ready for input to an image analysis model.

Output: Preprocessed image tensors representing the first and second images.

### Step 5:

The server performs stain detection and segmentation using a neural network.

The server feeds the preprocessed image tensors into a convolutional neural network configured for classification and segmentation. The server executes forward propagation to compute, for each image, a probability distribution over soil categories and a segmentation map indicating the probability that each pixel belongs to the soiled region.

Input: Preprocessed image tensors and trained model parameters stored on the server.

Operation: The server performs convolution, activation, pooling, and fully connected layer computations according to the neural network architecture. The server multiplies input tensors by learned weight matrices, adds biases, and applies non-linear functions. From the resulting logits, the server computes softmax probabilities for soil categories and per-pixel segmentation probabilities.

Output: Detected soil type, segmentation mask of the soiled region, and intermediate image-derived features such as region size and color statistics.

### Step 6:

The server constructs a combined feature vector representing stain and context.

The server combines the detected soil type and image-derived features with the material information, soil occurrence information, and elapsed-time information. The server encodes categorical values as numerical vectors and normalizes continuous values to create a unified feature vector that describes the stain condition in detail.

Input: Detected soil type, segmentation features, material information, soil occurrence information, and elapsed-time information.

Operation: The server maps each categorical attribute to a numeric representation (for example, one-hot encoding) and scales numeric attributes (for example, by subtracting a mean and dividing by a standard deviation). The server concatenates all encoded components into a single high-dimensional feature vector.

Output: A feature vector capturing combined stain, material, and time characteristics.

### Step 7:

The server evaluates stain severity and recommended cleaning intensity.

The server inputs the feature vector into an inference model such as a gradient boosting model or a feedforward neural network that has been trained to infer attributes like penetration degree, severity level, and recommended cleaning intensity.

Input: Combined feature vector and stored parameters of the inference model.

Operation: The server performs model-specific operations, such as traversing decision trees or multiplying by weight matrices and applying activation functions, to compute output scores.

The server then maps these scores to discrete levels (for example, “light,” “moderate,” or “severe” severity; “gentle,” “standard,” or “strong” cleaning intensity).

Output: Estimated stain severity level, penetration degree, and recommended cleaning intensity.

### Step 8:

The server generates search conditions for retrieving cleaning methods.

The server converts the soil type, material category, elapsed time category, severity level, and cleaning intensity into a set of search parameters. The server defines ranges and constraints that must be satisfied by candidate cleaning methods stored in a database.

Input: Detected soil type, material information, elapsed-time information, and inferred attributes from the inference model.

Operation: The server constructs a query specification that may include discrete values, inequalities, and logical combinations (for example, soil_type=X AND material IN {A, B} AND severity <=threshold). The server formats these conditions into a query language supported by the database.

Output: A search condition object or query statement ready for database execution.

### Step 9:

The server retrieves and ranks candidate cleaning methods from the database.

The server sends the generated query to a cleaning-method database. The server obtains multiple records representing candidate cleaning methods that match the search conditions.

The server computes a score for each candidate based on safety for the material, expected cleaning effectiveness, and workability.

Input: Search condition and database records matching the search condition.

Operation: The server retrieves records using database operations and then applies a scoring function that combines numerical indicators, such as match degree and empirical success rates, with weighting factors. The server sorts the candidates by score to identify the best method.

Output: An ordered list of candidate cleaning-method records, with one method selected as the optimal method.

### Step 10:

The server generates structured cleaning information from the selected method.

The server takes the selected cleaning-method record and decomposes it into components: required tools, detergents, liquid conditions, procedure steps, and caution statements. The server stores each component in a structured cleaning information object that explicitly links each step to its associated tools, detergents, and conditions.

Input: Selected cleaning-method record retrieved from the database.

Operation: The server parses fields from the record, creates distinct elements for each step, and attaches metadata identifiers to associate tools and cautions with relevant steps. This involves constructing lists and mappings in a data structure that can be programmatically traversed.

Output: A structured cleaning information object representing a machine-readable cleaning plan.

### Step 11:

The server constructs a prompt sentence for a generative AI model.

The server builds a natural-language instruction that describes the stain context and enumerates the structured cleaning information while constraining the generative AI model to remain within the selected method. The server explicitly inserts the material, stain type, elapsed time, and ordered steps into the prompt sentence.

Input: Structured cleaning information and context features (soil type, material, elapsed time).

Operation: The server concatenates textual templates with dynamic values, such as “The user has an item made of [material] with a [soil type] stain that occurred [elapsed time] ago,” followed by detailed steps from the structured cleaning information. The server also appends instructions such as “Avoid adding steps or materials that are not in the recommended method.”

Output: A complete prompt sentence in text form, suitable for input to a generative AI model.

### Step 12:

The server generates explanatory text via the generative AI model.

The server sends the constructed prompt sentence to a generative AI model and requests an explanatory text. The server specifies parameters controlling length and style. The generative AI model returns a natural-language explanation tailored to the provided prompt.

Input: Prompt sentence and generative AI model parameters.

Operation: The server transmits the prompt sentence to the model inference engine, triggers the model to perform internal attention and token generation computations, and receives a sequence of text tokens. The server reconstructs these tokens into a coherent explanatory text string.

Output: Explanatory text describing the cleaning method in natural language.

### Step 13:

The server validates and refines the explanatory text.

The server analyzes the generated text to ensure consistency with the structured cleaning information. The server checks whether mentioned tools, detergents, and steps appear in the structured data and whether there are any extraneous or contradictory recommendations.

Input: Explanatory text and structured cleaning information.

Operation: The server performs string matching or named-entity extraction to identify key terms in the generated text and compares them against the structured cleaning information. If the server detects inconsistencies, the server removes or edits problematic segments or, in some configurations, regenerates the text with a modified prompt.

Output: Validated explanatory text aligned with the structured cleaning information.

### Step 14:

The server assembles presentation output data, including media.

The server searches a media repository for images, diagrams, and videos associated with the selected cleaning method and its steps. The server associates each media item with corresponding procedure steps in the structured cleaning information. The server then constructs a presentation package that includes the explanatory text, step-by-step descriptions, and references to media resources.

Input: Validated explanatory text, structured cleaning information, and media entries from the repository.

Operation: The server builds a composite data structure that maps each step to its media items and text. The server encodes references to actual media files and may generate additional simple graphics to visualize motions such as dabbing or rinsing.

Output: Presentation output data containing text segments, structured steps, and media references.

### Step 15:

The server estimates the user emotional state and adapts content configuration.

The server receives user operation information and sensor information from the terminal, indicating how the user has interacted with previous outputs, such as frequent scrolling back to certain steps or prolonged viewing of warning sections. The server applies a user-state estimation model to classify the user emotional state. Based on this estimate, the server adjusts both the prompt strategy for future interactions and the structure of the current presentation output data.

Input: User operation information, sensor information, and presentation output data.

Operation: The server converts user interaction logs into time-series features, processes them through the user-state estimation model, and obtains a state label. The server then reorders or filters explanation segments, increases or decreases detail level, or changes emphasis on warnings in the presentation output data. The server may also update internal parameters to construct future prompt sentences with different levels of detail.

Output: Adapted presentation output data configured according to the estimated user emotional state.

### Step 16:

The server transmits the adapted presentation output data to the terminal.

The server encodes the adapted presentation output data into a format suitable for the terminal, sets response headers, and sends the data through the network. The server ensures that all references to media can be resolved by the terminal, either through embedded resources or accessible URLs.

Input: Adapted presentation output data.

Operation: The server serializes the composite data structure, applies compression if needed, and transmits it via the network interface to the terminal's designated endpoint.

Output: Network response containing adapted presentation output data delivered to the terminal.

### Step 17:

The terminal renders the explanatory content and media to the user.

The terminal receives the adapted presentation output data and parses its structure. The terminal maps explanatory text to text views, maps step definitions to interactive lists, and associates each step with corresponding image, diagram, or video components. The terminal then displays the content on the screen and, if applicable, plays videos through the media subsystem.

Input: Adapted presentation output data received from the server.

Operation: The terminal constructs a user interface layout, loads images into image views, instantiates video players for video references, and orders steps according to the configuration provided. The terminal updates the display and handles user inputs such as scrolling, tapping, and zooming.

Output: Visual and, where applicable, audio presentation of cleaning instructions on the terminal display.

### Step 18:

The user executes the cleaning procedure while interacting with the terminal.

The user follows the displayed instructions, prepares the indicated tools and detergents, and performs each step in the specified order. The user may pause, scroll, or replay specific parts of the explanation or media content as needed.

Input: Visual and textual instructions presented on the terminal and physical tools and detergents prepared by the user.

Operation: The user performs physical cleaning operations while referencing the step-by-step information and may interact with the terminal to clarify or review instructions. The terminal, in turn, records these interactions as updated user operation information.

Output: A physically cleaned object and additional interaction data that can be fed back to the server for further refinement of subsequent processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented cleaning support systems for industrial equipment mainly rely on static rule sets and manually designed decision trees to determine a cleaning method based on simple attributes such as a type of equipment or a category of contamination. In such systems, a processor typically selects one of a small number of pre-registered cleaning procedures without deeply analyzing image data, contextual history, or user interaction patterns. As a result, these systems exhibit several technical limitations in terms of information processing and human-machine interaction.

First, conventional systems are not configured to perform integrated, multi-stage processing of heterogeneous data including high-resolution images of contaminated regions, wide-field images of entire targets, material information, contamination history, and elapsed time. The absence of a pipeline that combines advanced image preprocessing, feature extraction, and machine-learning-based contamination classification results in low accuracy in identifying fine-grained contamination states, such as localized persistent oil, layered rust, or mixed contaminants on composite materials. This degrades the quality of downstream processing and reduces the effectiveness of the cleaning recommendations.

Second, conventional systems do not effectively leverage generative artificial intelligence models as programmable information-processing components. In particular, they do not systematically construct prompt sentences based on structured contamination-state data, nor do they validate or correct generated cleaning procedures by cross-referencing a curated knowledge base. Consequently, the use of generative models is either ad hoc or purely conversational, which may lead to inconsistent, unreliable outputs that are not tightly integrated into a deterministic processing pipeline.

Third, traditional systems provide limited support for generating and presenting multimodal instructional content. They often output only static textual instructions or manually created reference images, without dynamically generating visual content such as diagrams, still images, or animations tailored to a specific contamination state and machine configuration. This restricts the processor's ability to transform internal state representations into rich, context-aware visual guidance for the user, and prevents efficient reuse of computationally derived knowledge about the contamination and the cleaning steps.

Fourth, conventional systems are not configured to analyze user-side behavioral and biometric data so as to adapt the modality and granularity of information presentation in real time. User interfaces simply render predetermined screens, without any feedback loop that uses a user's emotional state or comprehension level to modify the content structure, sequence, or detail level. This leads to suboptimal human machine interaction, particularly in complex industrial cleaning tasks that may require repeated clarification or emphasis of specific hazards or steps.

Fifth, existing approaches do not tightly couple high-level, generative cleaning instructions with low-level control of automated work devices, such as industrial robots. Often, there is a manual translation step where a human operator converts recommended procedures into robot control commands. This breaks the end-to-end automation chain and prevents the processor from automatically generating, executing, and evaluating control-command sequences based on the same internal contamination-state representation used for planning and explanation. This decoupling also makes it difficult for the processor to iteratively refine cleaning operations based on post-cleaning image analysis.

Accordingly, there is a need for an improved computer-implemented technique in which a processor (i) performs advanced image processing and machine-learning-based classification on contamination-related images, (ii) generates structured contamination-state data and uses it to construct deterministic prompt sentences for generative artificial intelligence models, (iii) validates and augments generated cleaning methods by referencing a knowledge base, (iv) synthesizes tailored multimodal visual content, (v) adaptively controls information presentation based on user-state analysis, and (vi) automatically generates and refines control commands for an automated work device based on post-cleaning feedback. Such a technique would improve the overall functioning of the computer system by enabling more accurate and robust data processing, more effective multimodal content generation, and more reliable closed-loop control of automated cleaning operations.

The specific processing by the specific processing unit 290 of the data processing device 12 in Application Example 1 is realized by the following means.

The present invention provides a server comprising a processor configured to acquire multi-type input data from an imaging device and a user interface device, the multi-type input data including an image of a contaminated portion of a target surface, an image of an entire target including the contaminated portion, material information, contamination-history information, and elapsed-time information from adhesion of the contamination, to perform, by execution of image-processing instructions, image normalization and feature extraction on the images so as to generate feature values that represent a contamination region, to classify, by execution of machine-learning instructions using a trained discrimination model, a type and a degree of the contamination based on the feature values and to integrate a classification result with the material information, the contamination-history information, and the elapsed-time information so as to generate structured data describing a contamination state, to construct, by execution of natural-language-processing instructions, a prompt sentence in a natural language by embedding the structured data into a template, the prompt sentence including information relating to the contamination state, the material, safety conditions, and resource conditions for cleaning, to transmit the prompt sentence to a generative artificial intelligence model and receive, from the generative artificial intelligence model, cleaning-method information including cleaning steps and precautions, to search, by execution of database-query instructions, a knowledge base that stores cleaning-knowledge information associated with contamination types and materials, to compare and reconcile the cleaning-method information with the cleaning-knowledge information so as to derive an optimized cleaning method and a list of necessary cleaning resources, to obtain, from an internal storage or an external information source, supplier information corresponding to the necessary cleaning resources and to generate output data that associates the necessary cleaning resources with the supplier information, to generate, by execution of content-generation instructions using at least one of a generative artificial intelligence model, an image-generation model, and a video-generation model, multimodal visual content including at least one of descriptive text, graphic information, still-image information, and moving-image information that represents the optimized cleaning method and the necessary cleaning resources, to analyze, by execution of user-state-analysis instructions, user-state information based on input-operation data, biometric data, or browsing-behavior data acquired from the user interface device, and to dynamically adjust, based on an analysis result, a presentation format of the multimodal visual content and the output data, and to translate the optimized cleaning method into a sequence of control commands including a movement path, an acting force, a number of processing repetitions, and a processing target region for an automated work device, to transmit the control commands to the automated work device so as to cause execution of a cleaning process, and to acquire and re-analyze post-cleaning images by the same image-processing and machine-learning instructions so as to determine a necessity of additional cleaning and to update stored cleaning history. This enables an improvement in the functioning of the computer system by providing an integrated, closed-loop processing architecture in which the processor (i) converts raw multimodal input data into structured contamination-state representations, (ii) programmatically controls generative artificial intelligence models through deterministically constructed prompt sentences, (iii) validates and enhances generated cleaning instructions using a knowledge base, (iv) generates adaptive, multimodal guidance tailored to user state, and (v) automatically synthesizes and refines low-level control commands for an automated work device based on feedback, thereby increasing accuracy, robustness, and efficiency of computer-implemented contamination analysis and cleaning control.

The term “processor” refers to one or more hardware information-processing units, such as a central processing unit or a graphics processing unit, configured to execute instructions stored in a memory to carry out image processing, machine learning, natural language processing, database access, content generation, user-state analysis, and device-control operations described in the present specification.

The term “imaging device” refers to an apparatus including at least one image sensor and an optical system configured to capture image data of a target surface or an entire target object, and to output the image data as digital signals usable by the processor.

The term “target surface” refers to a surface portion of an object to be cleaned, such as a surface of industrial equipment, machinery, or a structural component, on which contamination may adhere and which is captured by the imaging device.

The term “image of a contaminated portion” refers to an image or an image region that visually represents a localized area of the target surface where contamination is present and is captured with sufficient resolution for analysis by image-processing algorithms.

The term “image of an entire target” refers to an image that captures a wider area including the entire or substantially entire object or installation to which the contaminated portion belongs, thereby providing contextual information such as relative position, shape, and surrounding environment of the contaminated portion.

The term “material information” refers to data indicating a material or a combination of materials of the target surface, such as metal, ceramic, polymer, coating layer, or composite material, which data is used by the processor to constrain or select cleaning methods.

The term “contamination-history information” refers to data indicating how the contamination occurred or accumulated over time, including factors such as source of the contaminant, frequency of exposure, and events leading to adhesion, and which is used by the processor to characterize the contamination state.

The term “elapsed-time information” refers to data representing a duration from a time at which contamination adhered to the target surface to a time of analysis or cleaning, expressed in a time unit such as minutes, hours, or days.

The term “image normalization” refers to processing operations performed on image data to convert the images into a standardized format, such as unified resolution, aspect ratio, color space, and bit depth, thereby enabling consistent downstream processing.

The term “feature values” refers to numerical or symbolic descriptors extracted from image data, including but not limited to color statistics, texture descriptors, geometric measures, and region-based indicators, which collectively represent characteristics of a contamination region.

The term “contamination region” refers to a region in an image that corresponds to a part of the target surface where contamination exists, the region being determined or approximated through image-processing operations such as segmentation or region extraction.

The term “trained discrimination model” refers to a machine-learning model, such as a neural network or a statistical classifier, that has been trained on labeled data to classify types and degrees of contamination based on input feature values or image representations.

The term “contamination state” refers to a representation of the current condition of contamination on the target surface, including at least a type of contamination, a degree or severity level, spatial characteristics, and contextual attributes derived from material, history, and elapsed-time information.

The term “structured data” refers to information formatted according to a predefined schema or data model, such as key-value pairs, records, or vectors, that explicitly encode attributes of the contamination state, enabling deterministic processing by the processor.

The term “natural language” refers to a human language, such as English, in which explanatory text and prompt sentences are composed for interpretation by human users and by natural-language-processing components of generative artificial intelligence models.

The term “prompt sentence” refers to a text sequence in a natural language that includes one or more instructions, descriptions, or constraints, and that is provided as input to a generative artificial intelligence model to control or guide generation of output content.

The term “generative artificial intelligence model” refers to a machine-learning model configured to generate content such as text, images, or video in response to input data including prompt sentences, the model being trained on large datasets to learn statistical patterns of data.

The term “cleaning-method information” refers to information output by the generative artificial intelligence model or retrieved from a knowledge base, the information including cleaning steps, precautions, parameter values, and descriptions relevant to removal or reduction of contamination.

The term “knowledge base” refers to an information storage structure, such as a database or a set of data files, that stores cleaning-knowledge information, including standardized procedures, safety constraints, and associations between contamination types, materials, and cleaning resources.

The term “optimized cleaning method” refers to a cleaning procedure derived by reconciling or integrating cleaning-method information output by a generative artificial intelligence model with cleaning-knowledge information in the knowledge base, in accordance with the contamination state.

The term “cleaning resources” refers to consumable or reusable items used in a cleaning process, including but not limited to cleaning agents, tools, implements, protective equipment, and accessories required to execute the optimized cleaning method.

The term “supplier information” refers to data indicating sources from which cleaning resources can be obtained, such as vendor identifiers, locations, communication information, product identifiers, availability status, and pricing, which data is associateable with specific cleaning resources.

The term “output data” refers to data structures generated by the processor that combine or associate the optimized cleaning method, the cleaning resources, and the supplier information, and that are formatted for presentation to a user or for further processing.

The term “visual content” refers to one or more items of machine-generated or machine-selected visual information, including graphic information, still-image information, and moving-image information, that visually represent cleaning steps, resources, or target surfaces.

The term “graphic information” refers to vector or raster representations including diagrams, flowcharts, icons, or annotations that schematically depict relationships or processes related to the cleaning method.

The term “still-image information” refers to non-moving image data, such as single-frame images or photographs, that visually depict states of the target surface, cleaning operations, or cleaning resources at particular points in the cleaning process.

The term “moving-image information” refers to time-varying visual data, such as animations or video sequences, that depict temporal progressions of cleaning operations or changes in the contamination state.

The term “image-generation model” refers to a generative artificial intelligence model configured to generate one or more still images in response to input data, such as prompt sentences or conditioning images, based on learned image distributions.

The term “video-generation model” refers to a generative artificial intelligence model configured to generate moving-image information, such as animations or video sequences, in response to input data including prompt sentences, storyboards, or reference frames.

The term “user interface device” refers to a computing device having at least one input component and at least one output component, such as a display, speaker, or touchscreen, by which a user can receive output data and visual content and provide input-operation data.

The term “user-state information” refers to information indicative of a user's emotional state, comprehension level, or engagement, the information being derived from input-operation data, biometric data, or browsing-behavior data acquired through the user interface device.

The term “input-operation data” refers to data representing user interactions with the user interface device, such as touch events, pointer movements, button activations, scrolling operations, and timing parameters of such interactions.

The term “biometric data” refers to data derived from a user's physiological signals or physical characteristics, such as heart rate, facial expressions, pupil dilation, voice tone, or body movements, which can be acquired by appropriate sensors and used to infer a user's state.

The term “browsing-behavior data” refers to data describing how a user navigates and views content on the user interface device, including page transitions, dwell times, content selection patterns, and viewing sequences.

The term “presentation format” refers to a set of parameters and rules that determine how information is rendered on the user interface device, including layout, sequence, level of detail, modality emphasis, and frequency of repetition of specific content items.

The term “work device” refers to a controllable machine configured to perform physical operations related to cleaning, such as an industrial robot, automated manipulator, or other actuated equipment capable of interacting with the target surface under command of the processor.

The term “control commands” refers to machine-readable instructions transmitted from the processor to the work device, the instructions specifying operational parameters such as movement paths, actuations, timings, forces, and repetitions required to perform a cleaning process.

The term “movement path” refers to a trajectory or sequence of positions and orientations in a coordinate space that the work device or a tool attached thereto is commanded to follow during execution of cleaning operations.

The term “acting force” refers to a magnitude and direction of mechanical interaction exerted by the work device or an attached tool on the target surface, including contact pressure or impact characteristics used in the cleaning process.

The term “processing repetitions” refers to a number of times that a particular cleaning action or sequence of actions is executed on the same or overlapping portion of the target surface.

The term “processing target region” refers to a spatial region on the target surface, defined in a coordinate system understandable by the work device, on which the work device is commanded to perform cleaning operations.

The term “cleaning process” refers to a sequence of physical operations executed by the work device or a human operator, guided by the optimized cleaning method, that acts on the target surface to remove, reduce, or modify contamination.

The term “post-cleaning images” refers to images acquired by the imaging device after at least part of the cleaning process has been executed, the images representing residual contamination or cleaned areas of the target surface.

The term “cleaning history” refers to stored data describing past cleaning operations on a target surface, including contamination states, cleaning methods used, control commands executed, results of post-cleaning analysis, and temporal information associated with such operations.

In one embodiment, a server cooperates with at least one terminal and at least one work device to implement the claimed system. The server includes at least one processor, a main memory, a nonvolatile storage device, and a network interface. The terminal includes at least a display unit, an input unit such as a touchscreen or keyboard, and optionally an imaging device. The work device includes an actuator and a control unit and is capable of executing physical cleaning operations on a target surface of industrial equipment.

The server executes a plurality of software modules stored in the nonvolatile storage device and loaded into the main memory. The server uses, for example, an operating system, an image-processing library (such as a general-purpose image-processing framework), a machine-learning framework (such as a general-purpose neural-network framework), and one or more generative AI models accessible via an application programming interface. The server further uses a relational database management system to store structured records representing contamination states, cleaning knowledge, resource lists, and execution history. The server receives, via a communication network, images of a contaminated portion and images of an entire target including the contaminated portion. The images are acquired by an imaging device mounted on the work device, such as a camera on an industrial robot, or an imaging device on a terminal, such as a built-in camera of a portable terminal. The server stores the raw image data in an image repository and registers metadata such as time, machine identifier, lens parameters, and imaging distance in a database table. The server normalizes the images by converting them to a standard size, aspect ratio, color depth, and color space. The server uses a specific image-processing library to perform resizing, color-space conversion (for example, RGB to Lab), and normalization of pixel intensity values. The server executes an image-analysis module that performs denoising, edge enhancement, and region extraction on the normalized images. The server applies a smoothing filter, such as a Gaussian filter with a predetermined kernel size, followed by an edge-detection operator, such as a gradient-based operator, to highlight boundaries between contamination and background. The server executes a segmentation algorithm, such as region growing or clustering in color-texture feature space, to identify a contamination region. The server then computes feature values, such as color histograms in a perceptual color space, texture descriptors such as local binary patterns, and geometric descriptors such as area, perimeter, and shape complexity. The server stores the feature values as a vector in a database table, with a schema including fields for each descriptor.

The server executes a contamination-classification module implemented using a trained discrimination model. In one embodiment, the server uses a convolutional neural-network classifier composed of multiple convolutional layers, pooling layers, and fully connected layers. The server constructs an input tensor either from the segmented contamination-region image or from the extracted feature vector. The server forwards the input tensor through the neural network to obtain probability scores for multiple contamination classes, such as oil-based contamination, particulate dust, corrosion, chemical residue, and mixed contamination. The server determines a primary class and a confidence value by selecting the class with maximum probability, and stores these values in association with the corresponding image record.

The server also receives, from the terminal, material information, contamination-history information, and elapsed-time information. The user enters, on the terminal, for example, that the target surface is painted steel, that the contamination is from a lubricant leak, and that the contamination has been present for 48 hours. The terminal transmits this data to the server in the form of structured fields. The server validates the input against controlled vocabularies and converts elapsed time to a canonical numeric representation. The server integrates the classification result, the material type, the contamination history, and the elapsed time into structured data representing a contamination state. The server stores this contamination state record in the database, using a schema with fields for contamination type, severity level, material, source description, elapsed time, and links to image records.

The server executes a prompt-construction module that converts the structured contamination state into a natural-language prompt sentence. The server selects an appropriate language template based on the material type and the contamination class. The server inserts values such as material description, contamination description, time duration, and safety constraints into placeholders in the template. The server thus generates a prompt sentence for a generative AI model. For example, the server generates a prompt sentence such as:

“The surface of a painted metal industrial machine is contaminated with machine oil that has been present for about 72 hours due to a lubricant leak. Please generate a safe, step-by-step cleaning procedure that does not damage the paint, and list the necessary tools and cleaning agents.”

The server logs the prompt sentence and associated contamination-state ID in the database for traceability.

The server transmits the prompt sentence and, optionally, structured parameters such as contamination class identifiers and material identifiers, to a generative AI model through an application programming interface. In one embodiment, the generative AI model is a large language model based on a transformer architecture, trained on technical documentation and safety guidelines. The server configures the model call with parameters such as maximum output length, temperature, and domain-specific system instructions. The server receives a generated response that typically includes multi-step cleaning instructions, recommended chemical agents, mechanical actions, safety equipment, and environmental considerations. The server parses the generated text using a natural-language-processing module. The server detects step markers, imperative verbs representing actions, and mentions of tools and agents. The server converts the free-form response into a structured representation with fields including step index, action verb, target area, tool type, agent type, contact time, repetition count, and safety flags. The server stores both the raw generated text and the structured representation in the database.

The server executes a knowledge-base reconciliation module that accesses a cleaning-knowledge table stored in a relational database. The table contains standardized cleaning methods, including tested parameters for different combinations of contamination type and material type. The server executes parameterized queries to retrieve candidate methods for the current contamination state. The server compares recommended agent types, concentration levels, temperature ranges, and contact times in the generated response with those in the standardized methods. The server applies algorithmic rules to resolve discrepancies, for example by restricting concentration ranges to safe limits against the given material and by inserting mandatory pre-rinse or post-rinse steps when required by standardized procedures. The server thus derives an optimized cleaning method that synthesizes the generative output and the curated knowledge. The optimized method includes an ordered list of steps, each with specific numerical parameters. The server records this optimized method in a separate table and marks its provenance by linking to the source prompt and the standardized entries used. The server executes a resource-selection module that maps each step of the optimized method to corresponding cleaning resources. The server queries a resource table that stores types of cleaning agents, tools, and protective equipment, together with material compatibility attributes and hazard ratings. The server selects resources whose attributes satisfy constraints derived from the optimized method and the material information. The server then queries a supplier table or external service to obtain supplier identifiers, locations, and product links for each resource. The server combines the optimized method, the resource list, and the supplier information into output data structured as linked records. This specific data structure enables efficient retrieval and update when the contamination state changes.

The server executes a visual-content generation module to create multimodal guidance. The server constructs visual prompt sentences based on the optimized method. For example, the server generates:

“Generate an instructional illustration showing a worker cleaning oil from a painted metal industrial machine panel using a neutral detergent and a microfiber cloth, highlighting the correct wiping direction and avoiding excessive pressure.”

The server transmits such prompt sentences to an image-generation model or a video-generation model. The server supplies additional conditioning information, such as a simplified outline of the machine surface, to guide the generated imagery. The server receives generated visual content, such as still images depicting each step or an animation illustrating the sequence of actions. The server stores this content in an image and video repository and registers metadata linking each visual element to a specific step of the optimized method.

The server executes a user-state analysis module. The server receives, via the terminal, input-operation data (for example, scrolling speed, step revisits, hesitation time on particular screens), and, where available, biometric data such as heart rate or facial-expression indicators obtained from sensors. The server applies a classification algorithm, such as a shallow neural network or a gradient-boosted decision tree, trained to map these signals to coarse-grained user states, such as “confident,” “uncertain,” or “overloaded.” The server further analyzes browsing behavior to detect which steps are repeatedly viewed or skipped.

The server uses the analysis result to adapt the presentation format of the content. When the server determines that the user is uncertain, the server increases the level of detail, inserts more visual aids, and slows down the automatic advancement of step displays. When the server determines that the user is experienced or confident, the server condenses text, reduces redundancy, and surfaces advanced options such as automatic execution by the work device. By controlling the layout, ordering, and density of information, the server improves comprehension while reducing cognitive overload, which constitutes a technical improvement in the user-interface subsystem.

The server executes a command-synthesis module that translates the optimized cleaning method into control commands for the work device. The server obtains kinematic and configuration data for the work device, such as joint limits, tool dimensions, and coordinate frames, from a configuration database. The server maps each cleaning step to an action type (for example, linear wiping motion, circular scrubbing, or spray pattern), and synthesizes a movement path represented as a sequence of waypoints in the device coordinate system. The server computes acting-force parameters and processing repetitions based on the severity of contamination. The server packages these parameters into a command sequence recognized by the work-device controller.

The server transmits the command sequence to the work device over an industrial communication protocol. The work device executes the commands and performs physical cleaning on the target surface. During or after execution, the work device captures new images of the cleaned area and transmits them back to the server. The server re-applies the same image-processing pipeline and discrimination model to the post-cleaning images to evaluate residual contamination. Because the same feature-extraction and classification algorithms are used before and after cleaning, the server computes a consistent metric, such as a residual contamination index, that directly reflects the effectiveness of the applied method.

The server uses this residual contamination index to decide whether to generate additional commands for further cleaning. If residual contamination remains above a threshold, the server modifies specific parameters, such as increasing wiping repetitions or adjusting tool pressure within safe limits, and sends refined commands. This closed-loop control, driven by machine-vision and classification results, improves the precision and reliability of automated cleaning compared to open-loop approaches.

The terminal presents the optimized cleaning method, the visual content, and the resource and supplier information to the user. The terminal displays the contamination classification, key parameters, and an overview of the recommended actions. The terminal enables the user to switch between a manual mode, in which the user follows the instructions visually, and an automatic mode, in which the work device performs cleaning under the server's control. The user can review step-by-step diagrams or play videos that correspond to each cleaning step, and can access resource details and supplier links as needed.

The user may input additional prompt sentences directly to the generative AI model through the terminal for clarification or for scenario exploration. Example prompt sentences include: “I detected dirt on the surface of this machine. The material is metal, and the dirt is oil. Please propose the optimal cleaning method.”

“There is rust on the stainless-steel piping of an industrial machine. The rust has been forming for about two weeks. Suggest a safe cleaning procedure and the tools I should use.”

“Dust and fine powder have accumulated on the plastic cover of a conveyor system. Recommend a cleaning method that avoids scratching the plastic surface.”

“Paint splashes have adhered to the aluminum frame of a production machine. The paint is solvent-based and has dried for 24 hours. Provide a detailed, step-by-step removal procedure and list suitable cleaning agents.”

“I found sticky residue on the rubber gasket of a chemical-processing machine, probably from solvent spills. Suggest a cleaning method that will not damage the rubber material.”

The server merges the responses to such prompt sentences with the structured contamination-state data and knowledge-base contents, ensuring that free-form generative outputs respect machine constraints and safety policies.

The described architecture provides multiple technical effects beyond mere automation of human reasoning. The server performs integrated, hardware-accelerated image processing and neural-network inference that reduce latency in contamination classification compared with manual inspection. The server uses structured contamination-state representations and deterministic prompt-construction rules, which standardize interactions with generative AI models and reduce variability in generated instructions. The server's reconciliation of generative outputs with a knowledge base ensures that cleaning methods are both context-specific and compliant with safety constraints. The server's user-state analysis module adaptively adjusts the presentation format in real time, improving usability and reducing communication overhead by avoiding unnecessary data transmission. The closed-loop control of the work device, grounded in quantitative post-cleaning analysis, achieves consistent levels of cleanliness and reduces over-cleaning, thereby optimizing energy and resource consumption.

In alternative embodiments, the server may employ different image-processing algorithms, such as frequency-domain filtering or deep segmentation networks, to extract contamination regions. The discrimination model may be an ensemble of neural networks or a hybrid model combining convolutional and transformer layers. The generative AI model may be deployed locally on the same server or accessed through a dedicated inference appliance. The knowledge base may be distributed across multiple data stores, and the work device may include different types of actuators, such as ultrasonic cleaning heads or high-pressure jets. The fundamental data structures, such as the contamination-state record, the structured prompt sentence, and the optimized cleaning-method representation, remain consistent across these variations, enabling the claimed system to be implemented with different hardware and software configurations while preserving the described technical advantages.

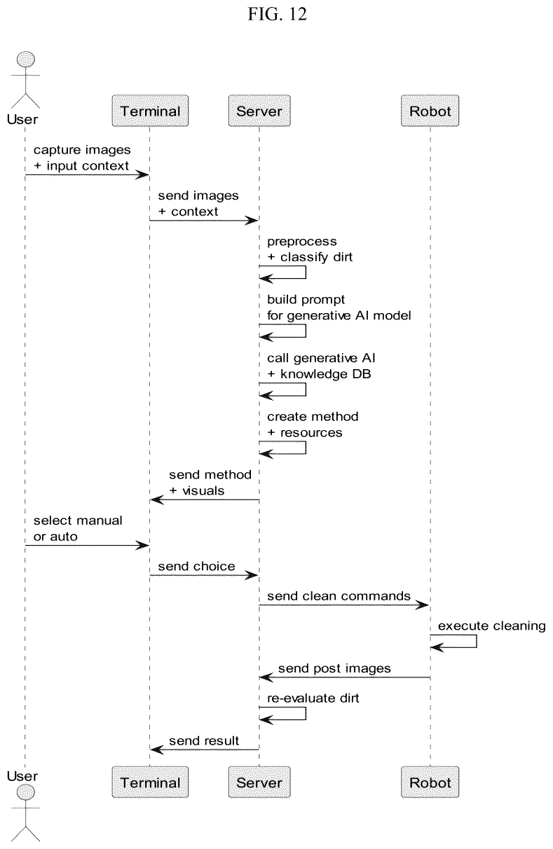

The following describes the processing flow using FIG. 12.

### Step 1:

The user operates the work device or the terminal to capture images of a contaminated portion and an entire target including the contaminated portion. The input is a real-world contaminated target surface, and the output is raw image data (for example, RGB frames) stored in the imaging device. The user positions the camera toward the dirty area, adjusts focus and distance, and triggers image capture so that both a close-up of the contamination and a wider contextual view are obtained.

### Step 2:

The terminal acquires the raw image data from the imaging device and associates the images with basic metadata such as time, equipment ID, and imaging conditions. The input is the raw image data and the imaging-device parameters, and the output is a structured data object that encapsulates the images and metadata in a transmissible format. The terminal encodes or compresses the images (for example, to JPEG), attaches identifiers and timestamps, and temporarily stores the data in local memory.

### Step 3:

The terminal transmits the structured image data to the server via a communication network using a predefined application protocol. The input is the structured image object held by the terminal, and the output is a network request that encapsulates the images and metadata as a message to the server. The terminal opens a secure connection, serializes the data into a request payload, and sends the payload to a specific endpoint of the server.

### Step 4:

The server receives the network request and stores the raw images and associated metadata in persistent storage. The input is the received request payload, and the output is a set of stored image files and corresponding database records in an image-metadata table. The server deserializes the payload, writes image files to a storage subsystem, and inserts metadata fields such as file paths, timestamps, device IDs, and preliminary status flags into the database.

### Step 5:

The server performs normalization of the received images to prepare them for further processing. The input is the stored raw image files, and the output is normalized images with standardized resolution, aspect ratio, color depth, and color space. The server loads each image into memory, applies resizing operations (for example, scaling to a fixed width and height), converts the color space (for example, from RGB to Lab), and scales pixel intensity values to a predefined numeric range.

### Step 6:

The server executes an image-denoising and edge-enhancement process on the normalized images. The input is the normalized image data, and the output is enhanced images in which noise is reduced and edges of contamination boundaries are emphasized. The server applies a smoothing filter (for example, a Gaussian kernel) to reduce sensor noise, then computes gradients or uses an edge-detection operator to highlight intensity transitions corresponding to contamination edges.

### Step 7:

The server performs contamination-region extraction through image segmentation. The input is the edge-enhanced image data, and the output is a binary or labeled mask that indicates regions likely to represent contamination. The server applies a segmentation algorithm, such as thresholding in a perceptual color space combined with connected-component analysis, or clustering in a feature space (for example, color and texture), and marks pixels belonging to the contamination region with region labels.

### Step 8:

The server calculates feature values from the contamination region to represent its characteristics. The input is the contamination-region mask and the normalized image, and the output is a feature vector containing numerical descriptors. The server extracts color histograms within the contamination mask, computes texture measures such as local binary pattern histograms, and calculates geometric properties such as area, perimeter, and shape descriptors, and then concatenates these values into a fixed-length feature vector.

### Step 9:

The server stores the feature vector and links it to the corresponding image records in the database. The input is the computed feature vector and image identifiers, and the output is a new database entry in a feature table. The server creates a record that includes feature values, image IDs, and processing version numbers, and writes this record through a structured query to the database.

### Step 10:

The server performs contamination-type classification using a trained discrimination model. The input is the feature vector or the cropped contamination-region image, and the output is a predicted contamination class and an associated confidence score. The server loads a pre-trained neural-network model, constructs an input tensor from the feature vector, forwards the tensor through multiple layers of the network, and obtains a probability distribution over contamination classes.

### Step 11:

The server determines a contamination severity level from the model output. The input is the probability distribution and internal model outputs such as logits or intermediate activation values, and the output is a discrete or continuous severity metric (for example, mild, moderate, severe or a normalized score). The server applies a decision rule or thresholding scheme to interpret model outputs in terms of contamination thickness or coverage and stores the severity metric in the database.

### Step 12:

The user inputs contextual information, including material type, contamination history, and elapsed time, via the terminal. The input is the user's knowledge about the target surface and events causing the contamination, and the output is structured contextual data items. The user selects material categories from dropdown lists, types a short description of how the contamination occurred, and enters or selects the time elapsed since contamination.

### Step 13:

The terminal sends the contextual data to the server, associating it with the corresponding image and feature records. The input is the structured contextual data collected from the user, and the output is a network message containing contextual fields and identifiers. The terminal packages the data into a request payload and transmits it to the server endpoint responsible for contamination-context updates.

### Step 14:

The server validates and normalizes the contextual data. The input is the raw contextual fields from the terminal, and the output is validated and normalized contextual records stored in the database. The server checks that the material type belongs to a predefined ontology, converts textual descriptions into canonical codes when possible, normalizes elapsed-time values into a numeric unit, and rejects or flags inconsistent entries.

### Step 15:

The server integrates the classification result and the contextual information into a contamination-state record. The input is the contamination class, severity level, and validated contextual data, and the output is a structured contamination-state record. The server constructs a record containing fields for contamination type, severity, material, origin description, elapsed time, and links to image and feature records, then stores it in a dedicated contamination-state table.

### Step 16:

The server constructs a prompt sentence in natural language based on the contamination-state record. The input is the contamination-state record, and the output is a textual prompt sentence conforming to a template. The server selects a template that matches the contamination type and material, substitutes variables such as contamination description, material description, and elapsed time into the template, and generates an English sentence or paragraph describing the situation and requesting an appropriate cleaning procedure.

### Step 17:

The server augments the prompt sentence with explicit safety and resource constraints. The input is the initial prompt sentence and material-related safety rules, and the output is an extended prompt sentence that includes instructions about what to avoid and what to consider. The server appends clauses such as “Do not damage the coating” or “Avoid strong solvents on rubber surfaces,” based on lookup rules tied to the material code, and finalizes a prompt sentence ready for submission to a generative AI model.

### Step 18:

The server sends the finalized prompt sentence to a generative AI model and configures generation parameters. The input is the finalized prompt sentence and optional structured parameters such as contamination-type identifiers, and the output is a generated text response containing candidate cleaning-method information. The server submits an API request including the prompt sentence, specifies parameters such as maximum token count and temperature, and receives a natural-language response describing cleaning steps and precautions.

### Step 19:

The server parses and structures the generated cleaning-method information. The input is the free-form generated text, and the output is a structured representation of cleaning steps, resources, and constraints. The server applies text-segmentation rules to divide the response into numbered or logical steps, extracts key phrases describing actions, tools, and chemical agents, assigns each extracted element to fields such as “action,” “tool type,” “agent type,” “duration,” and “safety notes,” and stores the structured representation in the database.

### Step 20:

The server retrieves relevant entries from a cleaning-knowledge base for reconciliation. The input is the contamination-state record and the structured generated method, and the output is a set of standardized cleaning procedures and parameters from the knowledge base. The server constructs and executes database queries using contamination type and material as keys, obtains candidate standardized methods, and loads them into memory for comparison.

### Step 21:

The server reconciles the generated method with the standardized methods to derive an optimized cleaning method. The input is the structured generated method and the standardized methods, and the output is a reconciled optimized method. The server compares step sequences, agent types, concentration levels, temperature ranges, and contact times; applies predetermined rules to resolve conflicts; enforces safety constraints; inserts mandatory steps that may be missing; and generates a final ordered step list with explicit numerical parameters.

### Step 22:

The server determines the necessary cleaning resources based on the optimized method. The input is the optimized method, and the output is a resource list specifying each needed tool, agent, and protective item. The server inspects each step to infer or confirm the required resource types, queries a resource database using type and compatibility attributes, and compiles a list that includes resource names, material compatibility, hazard classes, and usage instructions.

### Step 23:

The server acquires supplier information corresponding to the determined cleaning resources. The input is the resource list, and the output is an association between each resource and one or more suppliers. The server issues queries to an internal supplier database or external supplier services, retrieves data such as vendor identifiers, locations, product codes, and availability, and attaches this supplier information to the resource list.

### Step 24:

The server generates output data that combines the optimized cleaning method, the resource list, and the supplier information. The input is the optimized method and the annotated resource list, and the output is a composite output object suitable for presentation and further processing. The server structures the data into linked records that connect each step with the resources used in that step and the corresponding suppliers.

### Step 25:

The server constructs visual prompt sentences for generating explanatory images or video. The input is the optimized method and the contamination-state record, and the output is one or more visual prompt sentences describing scenes to be generated. The server converts each step into a textual description specifying the target surface appearance, the tool posture, and the motion direction, and concatenates these components into natural-language prompts directed to an image-generation model or a video-generation model.

### Step 26:

The server sends the visual prompt sentences to an image-generation or video-generation model and requests visual content. The input is the visual prompt sentences and optional conditioning data such as reference outlines, and the output is generated visual content representing the cleaning actions. The server transmits the prompts via an API, sets generation parameters such as resolution and style, and receives generated images or animations that visually depict the cleaning sequence.

### Step 27:

The server associates the generated visual content with individual steps of the optimized cleaning method. The input is the generated images or video segments and the optimized method, and the output is a mapping between method steps and visual elements. The server indexes each visual asset with a step identifier, stores the assets in media storage, and records references in the database so that the terminal can later retrieve the appropriate visual for each step.

### Step 28:

The server analyzes user-state information to adjust content presentation. The input is user interaction data and, where available, biometric or browsing-behavior data from the terminal, and the output is a presentation-adjustment profile. The server applies a user-state classifier that interprets patterns such as repeated step revisits or prolonged viewing time as indicators of uncertainty, and generates adjustment parameters specifying increased detail, additional visual aids, or slower progression through steps.

### Step 29:

The server prepares a response payload for the terminal that includes the optimized method, structured resources and suppliers, visual content references, and presentation-adjustment parameters. The input is the composite output object, the step-to-visual mapping, and the adjustment profile, and the output is a serialized payload ready for network transmission. The server encodes the data, ensures that resource links and media references are valid, and attaches header information indicating recommended presentation modes.

### Step 30:

The terminal receives the response payload from the server and renders the content for the user. The input is the payload transmitted by the server, and the output is a visual and interactive user interface on the terminal. The terminal decodes the data, constructs screens that show contamination classification, step-by-step textual instructions, thumbnails or controls for images and videos, and lists of resources and suppliers, while applying layout rules influenced by the presentation-adjustment parameters.

### Step 31:

The user reviews the presented information and selects either manual execution or automatic execution by the work device. The input is the rendered interface with the optimized method and resource information, and the output is a user command indicating the chosen execution mode. The user may inspect diagrams or animations, check resource details, and then activate a control to request robotic execution or to follow the instructions manually.

### Step 32:

The terminal transmits the user's execution command to the server. The input is the user command, including the identifier of the selected optimized method and the chosen mode, and the output is a control request message to the server. The terminal encapsulates the command and relevant identifiers into a request and sends it through the network to the server's control endpoint.

### Step 33:

The server generates a sequence of control commands for the work device based on the optimized method. The input is the optimized method and the work-device configuration, and the output is a command sequence including movement paths, acting forces, processing repetitions, and processing target regions. The server translates each step into kinematic and dynamic parameters, computes trajectories in the work-device coordinate system, and packages the parameters into a format accepted by the device controller.

### Step 34:

The server transmits the command sequence to the work device for execution. The input is the prepared command sequence, and the output is a set of control messages sent over an industrial communication channel. The server opens a session with the device controller, sends commands in the required protocol, and monitors acknowledgments or status codes to ensure that the commands are received and executed.

### Step 35:

The work device performs the cleaning operations according to the received commands and captures post-cleaning images of the target surface. The input is the control commands from the server, and the output is updated physical conditions of the target surface and post-cleaning image data. The work device moves its actuators along the specified paths, applies forces and cleaning agents as directed, and uses its imaging device to acquire images after or during cleaning.

### Step 36:

The terminal or work device transmits the post-cleaning images to the server. The input is the newly captured image data, and the output is a network message containing the post-cleaning images and identifiers linking them to the ongoing cleaning session. The terminal or controller sends the images using the same or similar protocol used for the initial images.

### Step 37:

The server reapplies the image-normalization, feature-extraction, and classification pipeline to the post-cleaning images. The input is the post-cleaning raw image data, and the output is updated feature vectors, contamination classifications, and severity metrics representing residual contamination. The server normalizes the images, extracts feature values for any remaining contamination regions, and passes these features through the trained discrimination model to obtain a residual contamination assessment.

### Step 38:

The server compares the initial and post-cleaning contamination metrics to determine the effectiveness of the cleaning and the need for additional cleaning. The input is the initial contamination severity and the residual severity metrics, and the output is a decision flag indicating whether additional cleaning is required and, optionally, parameter adjustments. The server computes differences or ratios between initial and residual measures and evaluates them against a threshold; if residual contamination exceeds the threshold, the server records that additional cycles are needed.

### Step 39:

The server either updates the control commands for another cleaning cycle or finalizes the cleaning session based on the decision. The input is the decision flag and any recommended parameter changes, and the output is either a new command sequence or a final status record. The server, in case of additional cleaning, modifies parameters such as repetitions or forces within safe ranges and sends new commands to the work device; otherwise, the server logs the completion status and stores the full cleaning history in the database.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented cleaning support systems are primarily configured to retrieve static instructions or documents from a storage device based on simple keyword search or rule-based matching. Such systems are unable to flexibly interpret diverse, free-form natural-language queries from users, and they typically cannot integrate heterogeneous input data such as images of contaminated regions, contextual information about materials, or temporal information about how long a contaminant has been present. As a result, these systems frequently provide generic instructions that are not well adapted to the actual state of contamination, thereby forcing the user to manually interpret and adjust the instructions, which increases cognitive load and reduces practical effectiveness. Further, many existing systems output only text-based guidance, or at best static images, which are not sufficient to visually convey multi-step cleaning procedures or subtle differences in application methods for cleaning agents and tools. When video content is provided, it is usually pre-recorded and not generated in real time according to the user's specific situation. Consequently, the system cannot dynamically adjust the content sequence, level of detail, or visual emphasis in response to the user's understanding or emotional state, leading to inefficient information delivery and poor user experience.

In addition, typical systems treat each user request independently, without maintaining an iterative interaction loop that evaluates the progress of the cleaning operation and refines subsequent guidance accordingly. Once an initial instruction is provided, the system generally does not incorporate updated images or additional prompt sentences describing residual contamination. This lack of iterative refinement prevents the system from functioning as an adaptive assistant that continuously optimizes its guidance based on real-world feedback. From a computer-technology perspective, there remains a need for an improved information processing architecture that can: (i) fuse natural-language prompt sentences and image data representing contaminated regions; (ii) construct and submit structured instruction prompts to one or more generative AI models; (iii) automatically generate coordinated text, image, and video content that is aligned step-by-step with a computed cleaning procedure; and (iv) dynamically control the presentation of such multimodal content at a user terminal based on the user's comprehension level, emotional state, and interaction history. Such an architecture should also support iterative processing cycles that leverage updated user inputs and environmental images to progressively refine the generated cleaning procedure.

The specific processing by the specific processing unit 290 of the data processing device 12 in Example 2 is realized by the following means.

The present invention provides a server comprising a processor configured to acquire, from a user terminal, a text-based prompt sentence related to a contaminant and image information related to the contaminant; to perform natural-language analysis on the prompt sentence to identify a type of the contaminant, a material of an object to be cleaned, and a request content of a user; to perform image analysis on the image information to identify a region and a state of the contaminant; to generate, based on results of the natural-language analysis and the image analysis, an instruction prompt sentence including instruction content for a generative AI model; to input the instruction prompt sentence to the generative AI model and thereby cause generation of explanatory text content including a cleaning procedure, tool usage, cleaning-agent usage, and safety information; to generate, based on the explanatory text content, an image-generation prompt sentence and a video-generation prompt sentence that represent visual scenes corresponding to respective steps of the cleaning procedure; to input the image-generation prompt sentence and the video-generation prompt sentence to an image-generation generative AI model and a video-generation generative AI model to generate image content and video content that visually present the cleaning procedure; to generate structured output data associating the explanatory text content, the image content, and the video content with individual steps of the cleaning procedure; to transmit the structured output data to the user terminal via a communication network; to perform iterative processing in which, based on an additional prompt sentence and updated image information received from the user terminal after execution of at least part of the cleaning procedure, a progress state of the cleaning procedure is evaluated and the cleaning procedure is updated stepwise by using the generative AI model again; and to estimate a comprehension level and an emotional state of the user based on operation-history information and reaction information from the user terminal and to adjust an information-presentation method by dynamically changing at least one of an order, a detail level, and a representation form of the explanatory text content, the image content, and the video content. This enables the server to implement an improved computer-based cleaning support platform that algorithmically fuses multimodal inputs, generates and updates multimodal output synchronized with a computed cleaning procedure, and adaptively controls presentation at the user terminal in response to user state and iterative feedback, thereby enhancing the technical performance and usability of the cleaning support system.

The term “system” refers to an information processing arrangement including at least one server, at least one user terminal, and one or more communication paths, which cooperate to execute the functions recited in the claims.

The term “processor” refers to one or more hardware processing units, such as a central processing unit or a graphics processing unit, configured to execute program instructions to perform the operations described in the claims.

The term “user terminal” refers to any information processing apparatus operated by a user, including a portable terminal, a stationary terminal, or a general-purpose computing device, that is capable of inputting information, displaying content, and communicating with the server over a network.

The term “prompt sentence” refers to a text-based input expressed in natural language, received from the user terminal, that describes at least a cleaning-related request, a situation of contamination, or a user query to be processed by the system.

The term “text-based” refers to information that is represented as character data in a linguistic form, as opposed to audio, image, or video signals.

The term “contaminant” refers to any foreign substance, stain, dirt, or unwanted material present on an object, for which a cleaning or removal procedure is to be determined.

The term “image information” refers to digital data representing at least one still image or at least one frame of a moving image, including pixel values or encoded image streams, capturing a region that includes the contaminant or an object to be cleaned.

The term “region of the contaminant” refers to a spatial area within the image information that corresponds to a location where the contaminant is present on an object.

The term “state of the contaminant” refers to one or more characteristics of the contaminant, such as amount, thickness, distribution, color, type, or degree of adhesion, as inferred from the image information or other inputs.

The term “material of an object to be cleaned” refers to a classification of the substrate or base object on which the contaminant is present, such as metal, glass, ceramic, polymer, textile, or wood, which may influence selection of an appropriate cleaning procedure.

The term “request content of a user” refers to a semantic interpretation of the intent or requirement expressed by the user in the prompt sentence, including at least one of a desired cleaning goal, a limitation condition, or a preferred type of guidance.

The term “natural-language analysis” refers to any computational processing of a text-based prompt sentence using linguistic or statistical techniques to derive structured information, such as entities, intents, or relationships.

The term “image analysis” refers to any computational processing of image information using pattern recognition, machine learning, or rule-based techniques to extract features, segment regions, classify objects, or estimate conditions related to contamination.

The term “instruction prompt sentence” refers to a structured text input generated by the processor and supplied to a generative AI model, which describes, in a machine-interpretable natural-language form, instructions or constraints for generating desired output content.

The term “generative AI model” refers to a machine learning model trained to generate new content, including text, images, or videos, in response to input data, using techniques such as neural networks, probabilistic models, or other data-driven algorithms.

The term “explanatory text content” refers to natural-language textual output generated by the generative AI model, including at least a cleaning procedure, usage instructions for tools and cleaning agents, and safety-related explanations.

The term “cleaning procedure” refers to an ordered set of one or more operations to be performed on an object to remove or reduce a contaminant, including preparation steps, application steps, waiting steps, and finishing steps.

The term “tool” refers to any physical implement or apparatus used during the cleaning procedure, such as a brush, cloth, sponge, scraper, or device for applying a cleaning agent.

The term “cleaning agent” refers to a substance used to facilitate removal of a contaminant, including a detergent, solvent, surfactant, chemical reagent, or other cleaning medium.

The term “safety information” refers to guidance related to safe handling of tools and cleaning agents, precautions to avoid damage to the object or environment, and measures to protect the user's health during the cleaning procedure.

The term “image-generation prompt sentence” refers to text describing a visual scene, generated by the processor, that is supplied to an image-generating generative AI model to cause generation of at least one image corresponding to a step of the cleaning procedure.

The term “video-generation prompt sentence” refers to text describing a dynamic visual sequence, generated by the processor, that is supplied to a video-generating generative AI model to cause generation of at least one video corresponding to a step of the cleaning procedure.

The term “image-generation generative AI model” refers to a generative AI model configured to output still images in response to at least one image-generation prompt sentence or other conditioning information.

The term “video-generation generative AI model” refers to a generative AI model configured to output moving-image content in response to at least one video-generation prompt sentence or other conditioning information.

The term “image content” refers to one or more digital images generated by the image-generation generative AI model, which visually depict at least a portion of the cleaning procedure, the tools, the cleaning agents, or the contaminated region.

The term “video content” refers to one or more digital moving-image sequences generated by the video-generation generative AI model, which visually depict at least a portion of the cleaning procedure in a temporal order.

The term “output data” refers to structured information that associates explanatory text content, image content, and video content with corresponding steps or elements of the cleaning procedure, and that is configured to be transmitted to and rendered by the user terminal.

The term “communication network” refers to any wired or wireless data communication infrastructure, including local networks, wide-area networks, or public networks, enabling data exchange between the server and the user terminal.

The term “iterative processing” refers to a sequence of processing cycles in which the processor repeatedly receives updated inputs, evaluates current conditions, modifies at least one aspect of the cleaning procedure, and regenerates corresponding output content.

The term “additional prompt sentence” refers to a subsequent text-based input from the user, provided after at least part of the cleaning procedure has been executed, that describes a result, a remaining problem, or a new request for adjustment.

The term “updated image information” refers to image information acquired after execution of at least a portion of the cleaning procedure, representing a current state of the contaminant or the cleaned object.

The term “progress state of the cleaning procedure” refers to an assessment of how far the cleaning procedure has advanced, including at least one of a remaining amount of contaminant, a degree of cleanliness, or completion of specific steps.

The term “comprehension level of the user” refers to an estimated degree of understanding by the user of the provided guidance, inferred from interaction behavior, response patterns, or other observable indicators.

The term “emotional state of the user” refers to an estimated affective condition of the user, such as frustration, satisfaction, confusion, or confidence, inferred from operation-history information, reaction information, or other signals.

The term “operation-history information” refers to data representing actions performed by the user at the user terminal, including input operations, navigation events, playback controls, or viewing duration for specific content.

The term “reaction information” refers to data representing explicit or implicit responses from the user, including feedback inputs, ratings, selections, or other measurable interactions that reflect the user's response to the presented content.

The term “information-presentation method” refers to a manner in which explanatory text content, image content, and video content are ordered, segmented, emphasized, or formatted for display to the user.

The term “order” refers to a sequence in which individual items of explanatory text content, image content, or video content are presented relative to one another.

The term “detail level” refers to a granularity or amount of information included in the presented content, such as the number of steps, the depth of explanation, or the inclusion of optional tips.

The term “representation form” refers to a mode or style of presenting content, including choices among text descriptions, diagrams, photos, animations, subtitles, highlights, or combined multimedia formats.

The term “information-processing apparatus” refers to any device including at least a processor, a memory, and an input/output interface, that is capable of executing instructions and handling data, and that may provide an image-capturing function.

The term “image-capturing function” refers to a capability of an information-processing apparatus to acquire digital image information using an imaging device, such as a camera or optical sensor, for use in the processing described in the claims.

The term “partial image” refers to an image that captures at least a portion of a region including the contaminant, with a field of view focused on a sub-area rather than an entire environment.

The term “overall image” refers to an image that captures a broader region including the contaminant and surrounding areas, providing contextual information about the location of the contaminant.

The term “scene information” refers to structured data representing a specific situation, step, or visual arrangement within the cleaning procedure, derived from explanatory text content and image content.

The term “subtitle information” refers to text to be displayed over video content, synchronized with a timeline, to provide captions, explanatory phrases, or step indications.

The term “highlight information” refers to visual markers, such as frames, colored overlays, or arrows, that emphasize particular regions or objects in image content or video content.

The term “guide information” refers to additional visual or textual indicators, such as icons, labels, or directional cues, that assist the user in understanding how to perform a step of the cleaning procedure.

The term “visual solution method” refers to a presentation of a cleaning procedure that primarily relies on visual elements, including images, videos, subtitles, highlights, and guides, to convey how to resolve a contamination-related problem.

In one embodiment, a server, a terminal, and a user cooperate to implement the claimed system. The server includes at least one central processing unit (CPU), at least one graphics processing unit (GPU), a main memory, a non-volatile storage device, and a network interface. The server executes software components implemented, for example, using a web application framework (such as a generic HTTP application framework), a machine learning runtime (such as a tensor computation library), and a database management system. The terminal includes at least one CPU, a memory, a display device, an input device such as a touch panel or keyboard, an image-capturing device such as a built-in camera, and a wireless or wired communication interface. The user operates the terminal to provide input and to view cleaning guidance.

The server stores, in the non-volatile storage device, a cleaning-support application program, a natural language processing module, a computer vision module, at least one generative AI model for text generation, at least one generative AI model for image generation, at least one generative AI model for video generation, and a set of trained model parameters. The server further stores metadata schemas and data structures used to represent prompt sentences, analysis results, cleaning procedures, and multimodal content. For example, the server uses a structured record including fields for a prompt sentence, a detected contaminant type, a detected substrate material, a list of cleaning steps, and identifiers of associated images and videos.

The terminal executes a user interface program that may be implemented as a web application rendered by a browser, or as a native application on a portable information processing apparatus. The terminal displays an input area where the user enters a prompt sentence in natural language, such as any of the following examples:

“I want to know how to remove oily stains from my gas stove.”

“How can I remove oily stains from my stainless steel stove? Please show me step-by-step instructions with pictures.”

“Please analyze this attached photo of my bathroom tiles and tell me how to remove the black mold. Generate a video that shows each step clearly.”

“There is a coffee stain on my white cotton shirt. Suggest a safe cleaning method and provide visual guidance for each step.”

The user operates the terminal to input the prompt sentence via the keyboard or touch panel. The user optionally activates a camera function of the terminal to capture a partial image focusing on a contaminated region and an overall image capturing surrounding areas. The terminal converts the captured optical signal from the camera into digital image data using an image sensor and an image signal processor. The terminal compresses the image data into a standard image format and stores the compressed image in a local memory buffer.

The terminal encapsulates the prompt sentence and the image data in a request message, for example encoded as character data and binary data in a predefined data structure, and transmits the request message to the server over a communication network using a network protocol stack. The terminal thereby enables the server to receive both textual and visual information about the contamination.

The server receives the request message via the network interface and buffers the message in the main memory. The server executes the natural language processing module to analyze the prompt sentence. The natural language processing module uses, for example, a tokenization process, a part-of-speech tagging process, and a named-entity recognition process implemented by a sequence model such as a bidirectional recurrent neural network or a transformer-based encoder. The server converts the prompt sentence into a sequence of tokens, maps the tokens to vector representations, and extracts features such as contaminant-related terms (for example “oily stains”, “black mold”, “coffee stain”), surface-related terms (for example “stainless steel”, “bathroom tiles”, “cotton shirt”), and intent-related expressions (for example “remove”, “clean”, “how can I”).

The server uses a classification sub-model implemented as a neural network, for example a multi-layer perceptron or a transformer-based classifier, to assign the prompt sentence to at least one contaminant category (such as oil-based stain, biological mold, pigment stain, mineral deposit) and to at least one surface category (such as metal, ceramic, textile, glass). The server stores the classification results as elements of an internal data structure that also contains tokenized text and feature vectors. By encoding the analysis results in this structured form, the server improves later processing efficiency and reduces repeated parsing operations when related prompts are processed iteratively.

The server executes the computer vision module to analyze the image data. The computer vision module uses a convolutional neural network (CNN) or a similar deep learning architecture, such as a residual CNN or an encoder-decoder segmentation network. The server first applies preprocessing operations, including resizing the image, normalizing pixel values, and converting color spaces, using a matrix operation library on the GPU. The server then inputs the preprocessed image to the CNN, which outputs a segmentation map or bounding boxes representing contaminant regions, and a class label indicating a contaminant type. The server calculates a “state of the contaminant” metric, such as stain coverage, estimated thickness, or degree of spread, by aggregating pixel-level outputs from the CNN. The server writes the segmentation result and associated metrics into the internal data structure alongside the natural language analysis results.

The server constructs an instruction prompt sentence for a generative AI model by combining the original prompt sentence, the extracted contaminant category, the detected material, and the state information. The server may use a template that includes sections such as “User request”, “Detected contaminant type”, “Detected material”, and “Detected contamination state”, and inserts the analyzed values into the template. This instruction prompt sentence defines constraints and goals for the subsequent generative process. For example, when the user enters “Please analyze this attached photo of my bathroom tiles and tell me how to remove the black mold. Generate a video that shows each step clearly.” and the CNN detects elongated dark regions along grout lines on a ceramic surface, the server generates an instruction prompt sentence that explicitly states that black mold is present in grout on ceramic tiles, and that a step-by-step video explanation is required.

The server inputs the instruction prompt sentence to a text generative AI model. The server may use a transformer-based autoregressive language model with multiple attention layers and a large vocabulary, trained on text data including cleaning manuals and material safety instructions. The server stores model parameters (weights and biases) in the non-volatile storage and loads relevant portions into GPU memory during inference. The server provides the instruction prompt sentence as a sequence of tokens and configures hyperparameters such as decoding temperature, maximum token length, and penalty terms for repetition. The GPU executes matrix multiplications and non-linear activation functions to compute attention weights and next-token probability distributions at each step. The server samples or selects tokens based on these distributions and appends them to generate explanatory text content that details a cleaning procedure, recommended tools, appropriate cleaning agents, and safety information.

The server improves computational efficiency by using a batched inference mechanism, wherein multiple user requests are processed concurrently, and by caching intermediate embeddings for frequently occurring contaminant types and materials. This reduces redundant computation when similar prompt sentences are processed, and lowers overall processing latency.

The server analyzes the generated explanatory text content to derive structured step information. The server identifies step headers such as “Step 1:”, “Step 2:”, and extracts corresponding descriptions. The server constructs a step-wise data structure, for example an ordered list where each element contains a step identifier, a textual description, and technical attributes such as required tools and contact time for cleaning agents. This step-wise representation is not only stored for later reference, but also used to drive downstream image and video generation and to align presentation on the terminal.

The server generates an image-generation prompt sentence for each step by synthesizing text that describes a visual scene. For instance, for a step instructing the user to “Apply neutral detergent to the oily surface using a microfiber cloth,” the server constructs an image-generation prompt sentence such as “A close-up of a stainless steel stove top with visible oily stains, a hand using a yellow microfiber cloth to apply clear neutral detergent in circular motions.” The server inputs each image-generation prompt sentence into an image generative AI model that may be implemented as a diffusion-based generative model. The image generative model receives a textual embedding and iteratively denoises a random noise tensor according to learned parameters to output a synthetic image. The server executes this process on the GPU to accelerate tensor operations, and stores the generated image as a file in a storage device, associating a file identifier with the corresponding step in the step-wise data structure.

The server generates a video-generation prompt sentence and an optional video script for one or more steps or for the entire cleaning procedure. The server may synthesize sentences that describe temporal progression, such as “Show the user spraying cleaning agent evenly, waiting for five minutes, and then scrubbing gently.” The server inputs the video-generation prompt sentence to a video generative AI model. In one embodiment, the video generative model uses a latent diffusion architecture extended to the temporal domain, where the server applies 3-dimensional convolutions or temporal attention mechanisms to produce a sequence of frames. Alternatively, the server uses generated images as keyframes and employs a video synthesis module to interpolate motion and assemble a video using a media processing library. In either case, the server encodes the frames into a compressed video format and stores a reference to the video in association with the relevant steps.

The server aggregates the explanatory text content, the image content, and the video content into a unified output record. The server uses a structured representation that links each step of the cleaning procedure with identifiers for text segments, image files, and video segments. This structure enables the server to efficiently deliver step-synchronized multimodal content to the terminal and, in particular, allows selective re-generation of content for specific steps in iterative processing, thereby reducing computational and communication overhead compared with regenerating entire instructions.

The terminal receives the structured output record from the server. The terminal parses the record and reconstructs a user interface in which each step is displayed with an associated description, at least one image, and an optional video preview. The terminal manages local caching of media to avoid repeated downloads and adapts the layout to screen size and orientation. By associating content at the step level, the terminal permits the user to quickly jump to relevant parts and reduces scrolling and searching operations.

The user views the step-wise guidance and performs physical cleaning operations in the real environment. The user can compare the generated images and videos with the actual contaminated object, which improves identification of the correct tools and operations. If a stain remains after executing certain steps, the user enters an additional prompt sentence such as “The stain is still visible after step 3. What should I do next?” or captures an updated image of the partially cleaned surface. The terminal transmits this additional prompt sentence and updated image to the server.

The server incorporates the additional prompt sentence and updated image into iterative processing. The server re-analyzes the updated image using the computer vision module to estimate residual contamination, and compares the estimated state with the previous state stored in the data structure. The server evaluates progress by calculating a difference in the area or intensity of the contaminant region. The server updates the instruction prompt sentence to include information about incomplete cleaning and re-invokes the text generative AI model to generate additional or modified steps. The server thereby refines the cleaning procedure based on objective visual evidence and explicit user feedback rather than repeating generic advice. This iterative loop improves accuracy and reduces the number of cycles needed to achieve satisfactory cleaning, which constitutes a technical improvement in system performance.

The server further implements a user-state estimation module. The server records operation-history information from the terminal, such as frequency of pausing videos, duration of viewing particular steps, number of replays, and rate of scrolling back to previous content. The server also receives reaction information such as explicit user ratings, button selections indicating confusion or satisfaction, or optional textual feedback. The server processes these signals using a feature extraction algorithm, for example aggregating view durations and event counts over time windows, and inputs the resulting feature vectors into a lightweight classifier implemented as a neural network or decision tree model. The classifier outputs an estimated comprehension level and an estimated emotional state for the user. The server dynamically adjusts the information-presentation method for subsequent outputs based on these estimates. For example, when the server detects low comprehension or negative emotional indicators, the server configures the text generative AI model to produce simpler and more detailed explanations, reduces the number of steps displayed at once, and increases the use of visual emphasis such as highlights and arrows in images. Conversely, when the server detects high comprehension and positive engagement, the server may combine multiple steps into a summarized view and reduce redundancy. The server also controls generation of subtitles and graphic overlays for videos. The server extracts scene information from the step-wise data structure, generates synchronized subtitles and highlight regions, and uses a video processing module to superimpose these on the video. This targeted adaptation of multimodal content based on user state improves the effectiveness of guidance and reduces unnecessary data transfer and computation by avoiding over-detailed content for expert users.

From a technical standpoint, this architecture yields several improvements beyond simple automation of human tasks. The fusion of natural-language analysis and image analysis enables the server to construct richer, machine-interpretable representations of contamination scenarios than either modality alone, which improves classification accuracy and reduces misguidance. The use of structured, step-wise data representation for cleaning procedures and multimodal content allows selective re-generation and re-transmission of content at the step level, which reduces processing load on the generative AI models and decreases communication bandwidth requirements during iterative refinement. The adaptive presentation control based on operation-history-derived features constitutes a non-conventional mechanism that modifies model outputs and interface behavior in response to measured system-internal signals, rather than relying solely on static templates. These interactions provide a specific improvement in computer technology by optimizing resource utilization (CPU and GPU cycles, memory bandwidth, network traffic), reducing average response time, and enhancing the reliability and precision of multimodal guidance compared with conventional rule-based or document-retrieval systems.

In alternative embodiments, the server employs different neural network architectures for the generative AI models and analysis modules. The server may use a recurrent neural network with attention for text generation in resource-constrained environments, or a smaller convolutional network for image analysis when GPU capacity is limited. The server may apply different training strategies, such as supervised fine-tuning of the text model on domain-specific cleaning datasets, data augmentation of image datasets by rotating and scaling contamination images, and optimization of loss functions that balance accuracy of contaminant detection with robustness to lighting variations. The server can also adopt alternative segmentation algorithms, feature extraction techniques, or classification layers while adhering to the same high-level data flow and step-wise multimodal content generation. In another embodiment, the terminal executes part of the analysis or generation locally. The terminal may implement a lightweight image classifier to perform initial contaminant type detection and only transmit a compact representation, such as feature vectors or region masks, to the server. This offloads computation from the server and reduces upload bandwidth for high-resolution images, thereby further improving system scalability and response latency. The server in turn adapts its model selection and processing path based on the availability and quality of such pre-processed data.

In summary, the server, the terminal, and the user interact through a series of concrete hardware-implemented operations, including acquisition and compression of images by the terminal's camera hardware, accelerated tensor computations by the server's GPU for text and image generation, structured storage and retrieval of step-wise multimodal records in a database, and adaptive user interface control at the terminal. These characteristics collectively enable a practical and technically enhanced cleaning support system that goes beyond abstract data processing by tightly coupling AI-based analysis and generation with real-world cleaning actions and device-level operations.

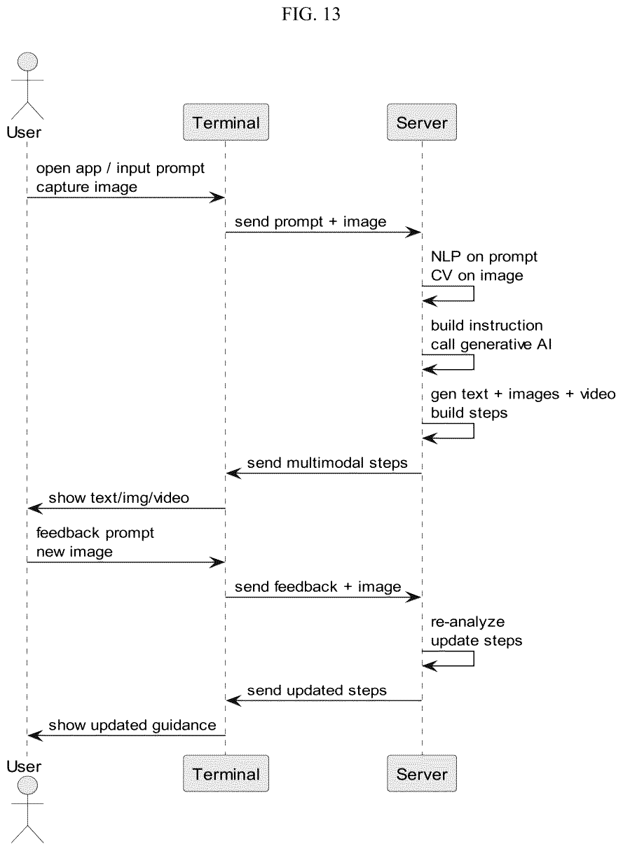

The following describes the processing flow using FIG. 13.

### Step 1:

The user operates the terminal to launch an application and display an input screen for a prompt sentence and image capture. The user inputs a text prompt sentence such as “How can I remove oily stains from my stainless steel stove? Please show me step-by-step instructions with pictures.” via a keyboard or touch panel. The user additionally operates a camera function of the terminal to capture a partial image of the contaminated region and an overall image of the surrounding area. The terminal receives, as input, raw text characters and raw image sensor data. The terminal converts the raw image sensor data into digital image data using an image signal processor, compresses the image data into a standard format, and stores the prompt sentence and image data in a local buffer as output for transmission. Step 2:

The terminal packages the buffered prompt sentence and image data into a structured request message and transmits the message to the server via a communication network. The terminal takes, as input, the local text and image buffers from Step 1. The terminal performs data processing that includes character encoding of the prompt sentence, binary encapsulation of the compressed images, and construction of a request header indicating data size and content type. The terminal outputs a network packet stream addressed to the server, containing the encoded prompt sentence and image data as payload.

### Step 3:

The server receives the network packet stream from the terminal and reconstructs the original request message. The server uses the network interface and protocol stack to assemble packets and then stores the reconstructed message in main memory. The server takes, as input, the packet stream from Step 2. The server decodes the header and payload, performs integrity checks, and parses the structured fields to separate the prompt sentence from the image data. The server outputs a request object that includes a text field holding the prompt sentence and an image field holding the digital image data for subsequent analysis.

### Step 4:

The server performs natural-language analysis of the prompt sentence to extract contaminant-related information and user intent. The server takes, as input, the text field from the request object of Step 3. The server tokenizes the text into word units, applies part-of-speech tagging, and maps each token to a vector representation using a word embedding table. The server feeds the sequence of vectors into a neural network classifier, such as a transformer-based encoder, and executes matrix multiplications and non-linear activations on a processing unit. The server calculates, as data processing, probability distributions over contaminant type classes (for example oil-based, mold, pigment), surface material classes (for example metal, ceramic, textile), and intent classes (for example cleaning request, follow-up request). The server outputs an analysis result structure that contains the original prompt sentence, detected contaminant type, detected material, and interpreted user request content.

### Step 5:

The server performs image analysis on the received images to locate the contaminant region and evaluate the state of contamination. The server takes, as input, the digital image data from the request object of Step 3. The server resizes the images to a standardized resolution, normalizes pixel values, and converts color space as preprocessing. The server inputs the preprocessed images to a convolutional neural network that outputs, as intermediate data, feature maps representing spatial patterns. The server then computes, using convolution layers and softmax classifiers, a segmentation mask or bounding boxes that indicate contaminant regions, and a class label indicating contaminant type. The server performs further data operations, such as counting contaminated pixels and calculating coverage ratio, to estimate the state of the contaminant. The server outputs an image analysis structure containing region coordinates, contaminant type confirmation, and state metrics.

### Step 6:

The server constructs an instruction prompt sentence for a generative AI model by combining the natural-language analysis and image analysis results. The server takes, as input, the analysis result structure from Step 4 and the image analysis structure from Step 5. The server executes string processing to insert detected values, such as contaminant type, material, and contamination state, into predefined prompt templates. The server concatenates template fragments and the original user wording into a single coherent instruction prompt sentence that specifies requirements for generated content, including desired output types (text, images, video). The server outputs a composed instruction prompt sentence ready for input to a generative AI model.

### Step 7:

The server generates explanatory text content by using a text generative AI model based on the instruction prompt sentence. The server takes, as input, the instruction prompt sentence from Step 6. The server tokenizes the sentence, maps tokens to embeddings, and feeds the embedding sequence into a transformer-based generative AI model that resides in memory. The server performs, as data processing, a sequence of attention operations, matrix multiplications, and activation functions to compute probability distributions for subsequent tokens. The server samples or selects tokens according to these distributions until an end-of-sequence condition is reached. The server concatenates the generated tokens into human-readable text describing a cleaning procedure, listing tools and cleaning agents, and specifying safety precautions. The server outputs explanatory text content structured into step-wise paragraphs for later association with visual content.

### Step 8:

The server derives structured step information from the explanatory text content to support aligned multimodal output. The server takes, as input, the explanatory text content from Step 7. The server executes text parsing to detect step markers, such as occurrences of “Step 1:”, “Step 2:”, and extracts the descriptions following each marker. The server converts the unstructured text into an ordered list where each element includes a step identifier, a description text, and attributes derived from keyword extraction, such as tool usage and waiting times. The server performs data operations such as splitting strings, indexing, and feature tagging. The server outputs a step-wise data structure that serves as a central representation for image and video generation and for later presentation control.

### Step 9:

The server generates image-generation prompt sentences for each step and creates corresponding image content using an image generative AI model. The server takes, as input, the step-wise data structure from Step 8 and the image analysis structure from Step 5. The server constructs, for each step, a textual description of a representative visual scene by combining the step description, detected material, and contaminant appearance into a prompt sentence. The server inputs each image-generation prompt sentence into an image generative AI model that implements a diffusion process. The server initializes random noise tensors and iteratively updates the tensors by applying learned denoising operations conditioned on the textual embeddings. The server decodes the final tensors into image arrays and encodes them as image files. The server outputs file identifiers for the generated images and updates the step-wise data structure to associate each step with its corresponding image content.

### Step 10:

The server generates video-generation prompt sentences and produces video content that visually presents the cleaning procedure. The server takes, as input, the step-wise data structure from Step 8 and optionally the generated images from Step 9. The server synthesizes a video-generation prompt sentence that describes a temporal sequence covering one or multiple steps. The server either inputs the video-generation prompt sentence into a video generative AI model that directly outputs sequences of frames or uses the generated images as keyframes and interpolates intermediate frames using a video synthesis module. The server executes frame composition and encoding operations, including frame ordering, addition of subtitles and highlight overlays based on step information, and video compression. The server outputs video file identifiers and appends them to the step-wise data structure to link each step or group of steps to video segments.

### Step 11:

The server assembles multimodal output data and transmits it to the terminal for presentation. The server takes, as input, the updated step-wise data structure from Steps 8, 9, and 10. The server constructs a structured response message in which each step is represented by a record containing explanatory text, image identifiers, and video identifiers. The server serializes this structure into a format suitable for network transmission and attaches metadata such as content length and content type. The server outputs a response message and sends it over the communication network to the terminal as a stream of packets.

### Step 12:

The terminal receives the response message and renders synchronized multimodal guidance to the user. The terminal takes, as input, the packet stream from Step 11. The terminal reassembles packets into the original response message, parses the structured data, and resolves image and video identifiers to retrieve or stream corresponding media files from the server. The terminal performs layout calculations to arrange text, images, and video playback controls step-by-step on the display. The terminal outputs a graphical user interface in which the user can read instructions, view images, and play videos aligned with each step of the cleaning procedure.

### Step 13:

The user observes the multimodal guidance on the terminal and performs physical cleaning actions in the real environment. The user takes, as input, the displayed text, images, and videos from Step 12. The user manipulates physical tools and applies cleaning agents to the contaminated object according to the instructions, using the images and videos as visual references for correct technique and extent. The user outputs, in the physical world, a partially or fully cleaned object, and may form an internal evaluation of whether further cleaning is necessary.

### Step 14:

The user provides iterative feedback by entering an additional prompt sentence and optionally capturing updated images reflecting the progress of cleaning. The user takes, as input, the current cleaning result and perceived remaining contamination. The user operates the terminal to input text such as “The stain is still visible after step 3. What should I do next?” and uses the camera to capture a new image of the surface. The terminal processes these inputs as in Steps 1 and 2, producing a new request message that contains an additional prompt sentence and updated image data as output for the server.

### Step 15:

The server performs iterative analysis and refinement of the cleaning procedure based on the additional prompt sentence and updated image data. The server takes, as input, the new request message from Step 14. The server repeats natural-language analysis and image analysis as in Steps 4 and 5, and compares new image metrics with prior metrics stored for the same session to compute a progress state, such as remaining contaminated area. The server updates the instruction prompt sentence to indicate incomplete cleaning and changed contamination state, and re-invokes the text generative AI model to produce additional or modified steps. The server generates new explanatory text content, and, if necessary, new image and video content for only the affected steps. The server outputs a refined step-wise data structure and transmits updated multimodal content to the terminal, thereby closing the iterative loop.

### Step 16:

The server estimates user comprehension and emotional state from operation-history information and reaction information acquired via the terminal and adjusts subsequent content presentation. The server takes, as input, logs of user interactions from Step 12 and any explicit reactions submitted by the user. The server aggregates these logs into feature vectors, performs numerical operations such as counting event frequencies and normalizing view durations, and inputs the feature vectors into a classifier to estimate comprehension level and emotional state. The server then modifies parameters for text generation and visual emphasis, such as increasing explanation detail or adding more highlights in images and videos, and updates layout and sequencing rules used for assembling the response message. The server outputs adapted multimodal content specifications that are reflected in later response messages, enabling the terminal to present information in a manner optimized for the current user state.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented cleaning support systems suffer from several technical limitations when processing heterogeneous input data and delivering context-appropriate guidance to users.

First, existing systems typically treat images and textual descriptions of stains as isolated inputs and apply fixed rule sets or static lookup tables to determine cleaning procedures. Such systems lack a unified structured representation that combines image-derived stain characteristics, material type, stain history, and elapsed time. As a result, the systems cannot reliably adapt to variations in stain type, surface material, or time-dependent changes in stain properties, leading to suboptimal or even harmful cleaning instructions. At the computer-architecture level, this fragmented processing causes redundant data flows between image-processing components, rule engines, and user-interface layers, increasing latency and processing load without improving decision quality.

Second, many systems rely on pre-authored, static instruction sets and do not exploit generative AI models in a controlled and programmable manner. When generative AI models are used, they are often invoked with ad hoc or manually crafted prompts. This lack of programmatic, context-aware prompt generation yields inconsistent outputs, makes validation difficult, and prevents systematic integration of model results with downstream components such as product databases and navigation engines. From the viewpoint of computer technology, this results in inefficient use of external AI services, unpredictable network traffic patterns, and increased error-handling overhead on the server.

Third, conventional solutions do not integrate extraction and normalization of cleaning tools and chemical agents from free-form AI-generated text into a structured product and location retrieval pipeline. Without automated parsing and canonicalization of item information, the server cannot efficiently query product databases, aggregate stock information from multiple sources, or compute optimized item recommendations. This leads to increased database query complexity, duplicated records, and additional manual mapping logic in the application layer, thereby degrading scalability and maintainability.

Fourth, user interfaces in typical systems are largely static and do not leverage computational models of user emotion to adapt the format and detail level of instructions. Emotion-insensitive presentation forces the server or client to transmit and render unnecessarily verbose or insufficiently detailed data irrespective of user state. This causes inefficient bandwidth usage, unnecessary computation for rendering unused content, and increased cognitive load for users in stressful conditions. The absence of an emotion-aware control layer means that the computing system cannot dynamically tune data volume, content complexity, and presentation order based on real-time user context.

Fifth, conventional systems do not tightly couple cleaning guidance with in-store navigation or location-based services at the system-architecture level. Store location data, inventory data, and navigation data are typically handled in separate applications, requiring the user to switch contexts manually. This separation leads to duplicated queries to backend services, inconsistent caching, and increased latency for obtaining route information. From a computer-technical perspective, there is no unified pipeline that converts high-level cleaning requirements, through AI-generated instructions, into concrete item identifiers, store locations, and navigation paths, all managed by a coordinated server.

Accordingly, there is a need for an improved computer-implemented system that (i) generates structured stain context from multimodal inputs, (ii) programmatically constructs and manages prompt sentences for generative AI models, (iii) automatically parses and normalizes AI outputs into item and location data, (iv) dynamically adjusts instruction content based on emotion estimation, and (v) integrates these elements into a unified server-side pipeline that reduces latency, improves robustness, and provides more efficient and adaptive guidance to users.

The specific processing by the specific processing unit 290 of the data processing device 12 in Application Example 2 is realized by the following means.

The present invention provides a server comprising a processor, a memory, a communication interface, and a storage device configured to acquire first image data of a stained region, second image data of an entire object including the stained region, material information of the object, situation information indicating how the stain occurred, and elapsed time information indicating a time elapsed since the stain occurred via a terminal device; to execute an image processing program on the first image data and the second image data to perform at least one of preprocessing, region extraction, feature extraction, and classification processing of a stain type, and to generate structured information regarding the stain by integrating a result of the classification processing with the material information, the situation information, and the elapsed time information; to generate, based on the structured information, a prompt sentence including an instruction sentence to be input to a generative artificial intelligence model, and to transmit the prompt sentence to the generative artificial intelligence model via the communication interface to obtain cleaning method information including cleaning procedure information and item usage information from the generative artificial intelligence model; to analyze the cleaning method information to extract item information indicating cleaning tools and chemical agents required for a cleaning operation, and, based on the item information, to search an item information storage device to retrieve candidate items and provision location information of the candidate items; to execute, based on at least one of voice information, image information, and text information related to a user, an emotion estimation process using an emotion estimation program to estimate an emotional state of the user, and to change at least one of a detail level of the cleaning method information, a presentation style of the cleaning method information, and a presentation priority of the candidate items in accordance with the emotional state; to generate, using at least one of the generative artificial intelligence model and an image processing program, explanation image data, explanation video data, or explanation graphic data associated with the cleaning method information, the candidate items, and the provision location information, and to construct output data in which respective steps of the cleaning procedure information are associated with corresponding ones of the explanation image data, the explanation video data, or the explanation graphic data; and to control, via the communication interface, the terminal device including the display device so as to cause the terminal device to receive the output data and interactively display, on the display device, text information of the cleaning procedure, the explanation image data, the explanation video data, or the explanation graphic data corresponding to the text information, and the provision location information of the candidate items. This enables the computing system to implement an integrated, pipeline-based architecture that transforms multimodal input into structured stain context, programmatically drives generative AI models through context-aware prompt sentences, automatically converts AI-generated text into normalized item and location data, and dynamically adapts the volume, structure, and visual presentation of cleaning instructions based on the user's emotional state, thereby improving processing efficiency, reducing latency and redundant data flows, and enhancing the technical performance and responsiveness of the cleaning support system as a whole.

The term “processor” refers to a hardware computation unit, such as a central processing unit or a logic processing circuit, that executes machine-readable instructions to perform data processing operations.

The term “memory” refers to a volatile or non-volatile storage medium, such as random access memory, configured to temporarily store programs and data for access by the processor.

The term “storage device” refers to a non-volatile information recording medium, such as a magnetic disk, an optical disk, or a semiconductor storage device, configured to persistently store programs, models, and data.

The term “communication interface” refers to a hardware and software interface, such as a network interface controller or wireless communication module, configured to send and receive data between the server and an external device over a communication network.

The term “display device” refers to an output apparatus, such as a liquid crystal display or organic light-emitting display, configured to visually present information to a user.

The term “terminal device” refers to an information processing apparatus, such as a mobile terminal, a portable computing device, or a head-mounted display device, that communicates with the server and provides user input and output functions.

The term “input device” refers to a component of the terminal device, such as a camera, a microphone, a touch panel, or a keyboard, configured to capture user input or environmental data.

The term “first image data” refers to digital image information representing a local region of an object on which a stain is present.

The term “second image data” refers to digital image information representing a wider area or an entire object that includes the region with the stain.

The term “material information” refers to data indicating a type, class, or property of a substrate or object to which the stain is attached, such as fabric, metal, wood, or synthetic material.

The term “situation information” refers to data indicating circumstances, causes, or processes by which a stain occurred, such as a spilled liquid, a dropped object, or a contact event.

The term “elapsed time information” refers to data indicating a duration from an occurrence time of a stain to a time at which the data is acquired or processed.

The term “image processing program” refers to a software component configured to perform operations on image data, such as preprocessing, region extraction, feature extraction, and classification of image regions.

The term “preprocessing” refers to a set of image operations, such as resizing, normalization, denoising, or contrast adjustment, performed to prepare image data for subsequent analysis.

The term “region extraction” refers to processing that identifies and isolates a region of interest, such as a stained area, from surrounding regions in image data.

The term “feature extraction” refers to processing that computes numerical or symbolic descriptors from image data, such as color features, texture features, or shape features, for use in classification or recognition.

The term “classification processing of a stain type” refers to computational analysis that assigns a stain region to one of multiple predefined classes, such as oil-based stain, water-based stain, protein-based stain, or pigment-based stain.

The term “structured information” refers to data represented in a predefined format, such as a record or an object, combining classification results, material information, situation information, and elapsed time information to describe a stain context.

The term “prompt sentence” refers to a text sequence including instructions or contextual information that is provided as input to a generative artificial intelligence model to request generation of an output.

The term “generative artificial intelligence model” refers to a trained computational model that receives a prompt sentence and outputs generated data, such as text, image data, or video data, based on learned patterns.

The term “cleaning method information” refers to information generated or selected by the system that includes cleaning procedure information and item usage information for removing or reducing a stain.

The term “cleaning procedure information” refers to data describing an ordered set of operations or steps to be performed to clean a stain from an object.

The term “item usage information” refers to data indicating how cleaning tools or chemical agents are to be used within a cleaning procedure, including quantities, application methods, or safety precautions.

The term “item information” refers to data indicating types or categories of physical articles, such as cleaning tools or chemical agents, that are required or recommended for a cleaning operation.

The term “cleaning tools” refers to physical implements used to perform cleaning operations, such as cloths, sponges, brushes, or scrapers.

The term “chemical agents” refers to substances used to chemically act on stains during cleaning, such as detergents, solvents, or cleaning compounds.

The term “item information storage device” refers to a storage resource, such as a database system, configured to store and provide item information including identifiers, attributes, and provision locations.

The term “candidate items” refers to one or more items retrieved from the item information storage device that satisfy at least a part of the requirements indicated by the item information extracted from the cleaning method information.

The term “provision location information” refers to data indicating a location at which a candidate item is available, such as a store identifier, a section identifier, an aisle number, or an online provision endpoint.

The term “voice information” refers to digital audio data representing speech or sound produced by a user.

The term “image information” refers to visual data, such as one or more digital images or video frames, representing a user or an environment.

The term “text information” refers to character data representing user input, system messages, or other textual content.

The term “emotion estimation process” refers to computational processing that analyzes at least one of voice information, image information, and text information to estimate an emotional state of a user.

The term “emotion estimation program” refers to a software component configured to execute the emotion estimation process, for example by applying a classification model or rule set to user-related data.

The term “emotional state” refers to information indicating a psychological condition of a user, such as stress level, calmness, frustration, or urgency, estimated from user-related data.

The term “detail level of the cleaning method information” refers to a degree of granularity or amount of explanation included in the cleaning method information, such as a number of steps, length of descriptions, or inclusion of background explanations.

The term “presentation style of the cleaning method information” refers to a manner in which the cleaning method information is expressed or arranged, such as text form, bullet list form, simplified form, or explanatory form.

The term “presentation priority of the candidate items” refers to an order or emphasis with which candidate items are displayed or recommended to a user.

The term “explanation image data” refers to image data generated to visually explain one or more steps of a cleaning procedure or one or more attributes of candidate items.

The term “explanation video data” refers to time-sequential visual data generated to visually demonstrate one or more steps of a cleaning procedure or a usage method of candidate items.

The term “explanation graphic data” refers to graphical data, such as diagrams, icons, or schematic drawings, generated to support understanding of cleaning procedures or item usage.

The term “output data” refers to a data set constructed by the server that associates steps of the cleaning procedure information with corresponding explanation image data, explanation video data, or explanation graphic data and includes provision location information of candidate items.

The term “interactively display” refers to controlling a display device such that a user can manipulate presentation of information, for example by scrolling, selecting steps, playing or pausing video, or opening detailed views.

The term “position information” refers to data indicating a geographic or spatial location of a user or a terminal device, such as coordinates or zone identifiers.

The term “route information” refers to data indicating a movement path from a current position to a target position, including one or more waypoints or navigation instructions.

The term “guidance information” refers to information presented to a user to indicate or suggest a route, direction, or action for reaching a provision location of a candidate item.

The term “augmented-reality display device” refers to a display apparatus, such as a head-mounted display or a mobile device display, configured to superimpose virtual information onto a view of a real environment.

The term “simplified explanation information” refers to cleaning method information that is generated or transformed to have reduced detail level or complexity relative to a base cleaning method, for easier comprehension.

The term “visual content” refers to image data, video data, or graphic data designed to visually convey cleaning procedures, item usage, or navigation information.

In one embodiment, a server, a terminal, and a user cooperate to implement the present invention. The server includes a processor, a memory, a storage device, and a communication interface. The terminal includes a processor, a camera, a microphone, a touch panel, and a display device. The user operates the terminal in a real environment such as a home, a factory, or a retail store.

The server executes a plurality of software modules stored in the storage device and loaded into the memory. The software modules include an image processing module, a stain classification module, a prompt generation module, a generative AI client module, a natural language parsing module, an item mapping module, an emotion estimation module, a visual content generation module, and an output composition module. The server implements these modules, for example, by using operating system functions of a general-purpose server computer and software libraries such as an image processing library (for example, an OpenCV-type library), a numerical computation library (for example, a NumPy-type library), and a machine learning framework (for example, a TensorFlow-type or a PyTorch-type framework).

The terminal captures image data and user input in the real world and transmits such data to the server. The user uses the terminal camera to obtain first image data of a stained region and second image data of an entire object including the stained region. The user further uses a graphical user interface on the terminal to input material information, situation information, and elapsed time information. The terminal packages the acquired data, for example, as a structured message, and transmits the message to the server via the communication interface using a network protocol such as HTTPS.

The server stores received image data and metadata in the storage device in association with a session identifier. The server represents each image as a multidimensional array, such as a three-dimensional array of pixel values with width, height, and color channels. The server uses the image processing module to convert compressed image formats into internal array representations, normalize pixel intensity values to a predetermined range, and perform geometric resizing to a fixed resolution. The server thereby creates image tensors suitable for input to the stain classification module.

The server uses the stain classification module to identify stain regions and stain types in the image tensors. In one embodiment, the server implements the stain classification module as a convolutional neural network having an encoder-decoder architecture with multiple convolutional layers, pooling layers, and upsampling layers. The server trains this neural network in advance using supervised learning with a large number of annotated stain images. The server uses a cross-entropy loss function for stain type classification and a Dice or intersection-over-union loss function for region segmentation. The server updates network weights during training using a gradient-based optimization algorithm such as stochastic gradient descent with momentum or an adaptive learning rate algorithm. During training, the server applies data augmentation techniques such as random rotation, random scaling, color jittering, and noise injection to increase robustness against variations in lighting and camera angle.

The server inputs the normalized image tensors to the trained neural network. The server obtains, as output, a segmentation mask that indicates a stain region and a probability distribution over stain types. The server post-processes the mask using morphological operations to refine region boundaries and computes region-based features such as area, centroid, average color, and texture descriptors. The server selects a stain type by evaluating the probability distribution and applying thresholds or tie-breaking rules. The server represents these results in a structured stain record that includes the stain type, region coordinates in the image, geometric features, and confidence scores.

The server integrates the stain record with the material information, situation information, and elapsed time information. The server uses a predefined schema to store this integrated information as structured information. For example, the server creates a record including fields such as “material_category”, “stain_category”, “occurrence_cause”, “elapsed_time_minutes”, and “region_features”. The server may also apply rule-based logic to derive constraints from combinations of fields, such as “avoid_chlorine” when the material is a natural fiber and the stain type is a bleach-sensitive category. The server stores such constraints in the structured information.

The server uses the prompt generation module to generate a prompt sentence for a generative AI model. The server accesses the structured information and fills a prompt template that includes a context portion, a constraint portion, and an output requirement portion. The server concatenates these portions with predefined delimiters and ensures that all essential fields are expressed in natural language. The server thereby generates prompt sentences that systematically encode image-derived features and user-provided metadata, rather than ad hoc free-text prompts.

The server may generate different types of prompt sentences for different purposes. For example, the server may generate a first prompt sentence for a technical cleaning method, a second prompt sentence for a simplified explanation, and a third prompt sentence for visual content design. The server may generate a first prompt sentence such as:

“There is a red wine stain on a beige wool carpet. The spill occurred about 60 minutes ago. The user is at home and has basic household supplies. Describe the safest and most effective cleaning procedure in clear English, using short numbered steps. Avoid any method that could damage wool or cause color fading.”

The server may generate a second prompt sentence for a stressed user such as:

“The user spilled coffee on a cotton shirt 2 hours ago and feels very stressed. Propose a cleaning method that can be explained in three simple steps and can be performed in under 10 minutes, using commonly available household items.”

The server may generate a third prompt sentence for industrial use such as:

“There is an oil-based stain on an epoxy-coated factory floor, caused by leaked hydraulic oil 30 minutes ago. The user has access to professional cleaning tools and industrial degreasers. Propose a safe and efficient cleaning method. Include required tools, type of detergent, personal protective equipment, and step-by-step instructions. Keep the explanation under 10 steps.”

The server uses the generative AI client module to transmit the generated prompt sentence to a generative AI model executed on a remote computing resource. In one embodiment, the server accesses a transformer-based generative AI model that has been trained on a large corpus of text data. The server transmits the prompt sentence and model parameters such as temperature, maximum token length, and response format restrictions via the communication interface. The server receives a generated text response that includes cleaning method information, cleaning procedure information, and item usage information.

The server uses the natural language parsing module to analyze the generated text response. The server tokenizes the text, identifies sentence boundaries, and applies part-of-speech tagging using a natural language processing library. The server extracts item names, quantities, and application methods by matching phrases against lexical patterns and domain-specific dictionaries. The server normalizes extracted item names to item categories such as “cloth”, “household detergent”, “oxygen-based bleaching agent”, and “degreasing agent”. The server stores item information in a normalized data structure with item categories, attributes, and required properties.

The server uses the item mapping module to associate normalized item categories with stored product records in the item information storage device. The server maintains a database of products that includes product identifiers, category codes, physical sizes, safety attributes, inventory status, and provision location information such as store identifiers, aisle numbers, and shelf positions. The server executes a database query that matches normalized item categories to candidate products and retrieves a candidate set of items. The server may rank candidates by criteria such as proximity to the user's location, inventory level, product rating, or compatibility with user-specified constraints. The server thereby constructs candidate items and corresponding provision location information.

The server uses the emotion estimation module to estimate a user's emotional state. The terminal captures voice information, image information, or text information from the user and transmits such information to the server. The server may implement the emotion estimation module as a neural network-based classifier that processes speech features, facial expression features, or linguistic features. For example, the server may compute mel-frequency cepstral coefficients from voice data, facial landmark coordinates from image data, or sentiment scores from text data. The server may use a multi-layer neural network trained with supervised learning to map such features to emotion labels such as “stressed”, “calm”, or “frustrated”. The server may use a cross-entropy loss function for training and an optimization algorithm to update network weights. The server stores an emotional state label and a confidence score in association with the session.

The server modifies the cleaning method information and item presentation based on the emotional state. For a “stressed” user, the server selects or regenerates a simplified version of the cleaning procedure with fewer steps and shorter sentences. The server may generate an additional prompt sentence such as:

“Rewrite the following cleaning procedure for a very stressed user who needs a fast and simple explanation. Use at most three numbered steps and very short sentences.” The server sends the additional prompt sentence and the original procedure text to the generative AI model and receives modified text. For a “calm” user, the server may select a detailed explanation that includes background reasons for each step. The server also adjusts the ranking of candidate items, giving higher priority to items with immediate availability for a stressed user and higher priority to high-performance or specialized items for a calm user. This adaptive control reduces information volume and complexity when necessary and enhances responsiveness.

The server uses the visual content generation module to generate explanation image data, explanation video data, or explanation graphic data. The server may generate a prompt sentence for an image generation model such as:

“High-resolution instructional illustration showing a hand blotting a red wine stain on a beige wool carpet with a white cloth. The bottle of sparkling water is visible next to the carpet. Style: simple, clear, and realistic.”

The server sends this prompt sentence to an image generative model implemented on a computing resource that executes a diffusion-based algorithm or another generative algorithm. The server receives synthesized image data and stores the image data in the storage device.

The server may use an image processing program to adjust resolution, compress the image, and add labels or arrows.

The server may also generate a prompt sentence for a video generation model, such as: “Create a 30-second step-by-step video showing: 1) user pouring sparkling water on a red wine stain on a beige wool carpet, 2) user blotting with a white cloth, 3) final clean carpet. Camera angle: top-down. Add simple text labels for each step.”

The server receives video frames or a video file and uses a video processing library to encode, segment, and annotate the video. The server associates each image or video segment with a corresponding step in the cleaning procedure information. The server builds an output data object that contains text descriptions, associated images or videos, and provision location information of candidate items.

The server transmits the output data to the terminal via the communication interface. The terminal decodes the output data and presents an interactive interface on the display device.

The terminal displays text describing each cleaning step and displays an associated image or video beside or above the text. The terminal allows the user to select a step, enlarge an image, play or pause a video, or view detailed information for a candidate item.

In one embodiment, the terminal uses a location sensor such as a global navigation satellite system receiver or an indoor positioning module to obtain position information of the user.

The terminal transmits the position information to the server. The server uses a routing algorithm to compute route information from the user's current position to a location where a candidate item is provided. The server may use a graph-based algorithm in which nodes represent store sections and edges represent navigable paths. The server outputs a sequence of instructions or waypoints. The terminal displays guidance information, such as a map with an overlaid route or an augmented reality view that superimposes arrows on a real-time camera image.

This architecture yields technical effects beyond mere automation of human decision making. The server reduces overall processing time by performing stain segmentation and classification in a single neural network pipeline, thereby avoiding separate, sequential image analysis steps with redundant data transfers. The server improves accuracy by integrating image-derived features with material and time metadata in a structured representation, which in turn allows context-sensitive prompt generation and constraint enforcement. The server reduces network and computation load by dynamically adjusting the level of detail in instructions and by generating simplified views for stressed users, thereby decreasing the amount of data transmitted and rendered when a detailed view is unnecessary.

The server further improves data management by normalizing item information and mapping it to canonical product categories, which enables efficient database indexing and retrieval. The server avoids naive free-text matching and instead uses structured mapping, reducing query errors and inconsistencies. The server implements nonconventional processing flows in which generative AI outputs are parsed, normalized, and integrated with product and navigation data, rather than being directly displayed as unstructured text.

The server uses specific neural network architectures, training procedures, loss functions, and data augmentation techniques to realize robust stain classification and emotion estimation under varying imaging and acoustic conditions. The server also uses specific data structures for structured information, prompt templates, normalized item records, and navigation graphs. These technical measures collectively improve computational efficiency, reduce error rates, and provide stable and predictable system behavior when interacting with external generative AI models.

Alternative embodiments are possible. The server may use different neural network architectures, such as a transformer-based model for stain classification, or may employ hybrid models combining rule-based processing with neural inference. The server may implement the emotion estimation module entirely on the terminal for privacy reasons and exchange only emotion labels with the server. The server may generate visual content using pre-stored templates and overlay them with dynamic labels instead of synthesizing images from scratch. The server may execute all modules on a single physical machine or distribute them across multiple machines in a cloud computing environment. The terminal may be a smartphone, a tablet, a wearable device, or a dedicated cleaning-support device with a fixed camera and display.

In all embodiments, the server, the terminal, and the user cooperate to implement a technically specific data pipeline that starts from real-world image and sensor acquisition, executes structured analysis and generative modeling under predefined constraints, and returns adapted, visual, and location-aware cleaning guidance. This configuration improves the operation of the computer system itself in terms of processing speed, accuracy, data handling, and resource usage, and provides an integrated solution that could not be achieved by simple manual procedures or straightforward automation of human decision steps.

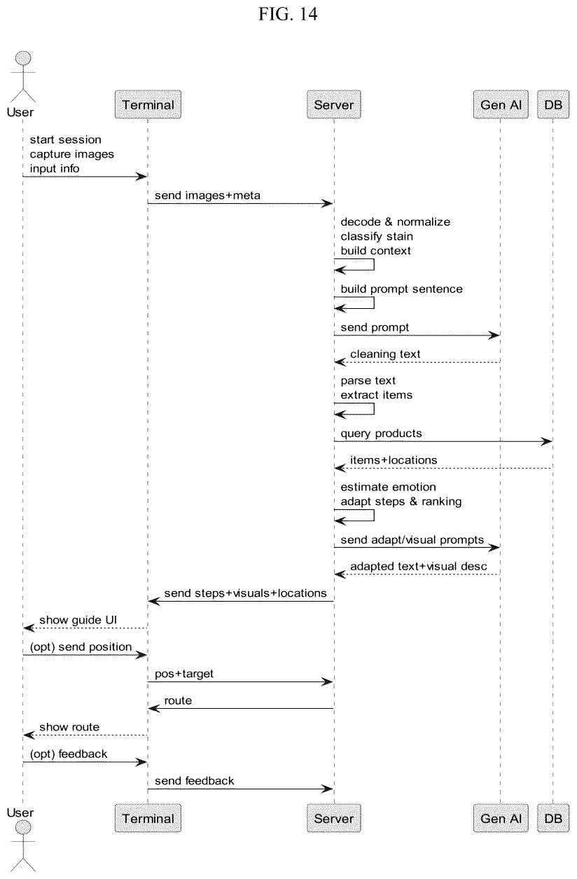

The following describes the processing flow using FIG. 14.

### Step 1:

User operates the terminal to start a cleaning support session.

User uses the terminal camera to capture first image data of a stained region and second image data of an entire object including the stained region. The input is real-world visual information of the stain and its surroundings, and the output is a pair of digital image files stored temporarily in the terminal.

### Step 2:

User inputs material information, situation information, and elapsed time information through a graphical user interface on the terminal. The input is user knowledge such as “wool carpet,” “spilled red wine during dinner,” and “about 60 minutes ago,” and the output is structured text fields stored as key-value pairs in the terminal's memory.

### Step 3:

Terminal packages the first image data, the second image data, and the structured text fields into a request message. The input is the captured images and metadata, and the output is a formatted data structure, for example a JSON object with attached binary image data and session identifiers, ready to be sent to the server.

### Step 4:

Terminal transmits the request message to the server via the communication interface using a network protocol such as HTTPS. The input is the packaged request message, and the output is an encrypted network payload delivered over the network to the server's communication interface.

### Step 5:

Server receives the request message and stores the raw images and metadata in the storage device. The input is the encrypted network payload, and the server performs decryption, parsing, and validation to obtain image bytes and text fields. The output is a set of records persisted in the storage device and a corresponding in-memory representation including image buffers and a metadata object.

### Step 6:

Server converts the compressed image data into internal array representations and normalizes the images. The input is the raw image bytes, and the server uses an image processing library to decode JPEG or PNG images into multidimensional pixel arrays, rescale them to a fixed resolution (for example, 512×512), and normalize intensity values to a standard range. The output is a pair of normalized image tensors suitable for numerical processing.

### Step 7:

Server executes a stain classification neural network on the normalized image tensors. The input is the normalized image tensors, and the server feeds these tensors into a convolutional neural network that computes convolution, pooling, and activation operations layer by layer to produce a segmentation mask and a stain type probability distribution. The output is a refined stain region mask, region features such as area and centroid, and a selected stain type label with a confidence score.

### Step 8:

Server integrates the stain classification results with the user-provided metadata to generate structured stain information. The input is the stain region features, the stain type label, the material information, the situation information, and the elapsed time information. The server constructs a structured record by assigning these values to predefined fields and calculates derived attributes such as “avoid chlorine” when specific material and stain combinations are detected. The output is a structured stain context object stored in memory and optionally in the storage device.

### Step 9:

Server generates a prompt sentence for a generative AI model based on the structured stain context. The input is the structured stain context object, and the server fills a prompt template by concatenating text fragments that describe the stain, the material, the elapsed time, and any cleaning constraints, and by appending explicit instructions about output format and safety. The output is a completed prompt sentence such as “There is a red wine stain on a beige wool carpet. The spill occurred about 60 minutes ago. The user is at home and has basic household supplies. Describe the safest and most effective cleaning procedure in clear English, using short numbered steps. Avoid any method that could damage wool or cause color fading.” Step 10:

Server transmits the prompt sentence to a generative AI model and receives cleaning method information. The input is the prompt sentence and configuration parameters such as temperature and maximum token length. The server sends these parameters via an API client to a remote generative AI model and receives a generated text response. The output is cleaning method information including cleaning procedure steps and item usage instructions represented as a text block.

### Step 11:

Server parses the generated text to extract item information and procedural structure. The input is the text block received from the generative AI model, and the server uses a natural language processing library to tokenize the text, identify numbered steps, and detect phrases corresponding to tools and chemicals. The server maps extracted phrases to normalized item categories by applying domain-specific dictionaries and pattern rules. The output is a list of ordered procedure steps and a normalized item list with categories such as “cloth,” “household detergent,” and “oxygen-based bleach.”

### Step 12:

Server queries an item information storage device to retrieve candidate items and provision location information. The input is the normalized item list, and the server formulates database queries that match item categories to stored product records. The server retrieves product identifiers, inventory status, and location fields such as store identifiers and aisle numbers. The output is a candidate item set, each element including product attributes and provision location information.

### Step 13:

Server receives user-related signals for emotion estimation and computes an emotional state. The input is at least one of user voice data, user facial image data, or user text messages transmitted from the terminal. The server extracts features such as acoustic descriptors, facial landmarks, or sentiment scores and feeds these features into an emotion estimation model, which computes probability values for emotion classes. The output is an emotional state label, such as “stressed” or “calm,” with an associated confidence score.

### Step 14:

Server adjusts cleaning method information and item ranking according to the emotional state. The input is the base cleaning procedure steps, the candidate item set, and the emotional state label. The server may generate a secondary prompt sentence, such as “Rewrite the following cleaning procedure for a very stressed user who needs a fast and simple explanation. Use at most three numbered steps and very short sentences,” and send it to the generative AI model along with the original steps to obtain a simplified procedure. The server also reorders candidate items by applying ranking rules that prioritize easily obtainable products for a stressed user or high-performance products for a calm user. The output is an emotion-adapted cleaning method and an emotion-adapted candidate item ranking.

### Step 15:

Server generates visual content prompts and obtains explanation images or videos. The input is the emotion-adapted cleaning method and the structured stain context. The server constructs visual prompts such as “High-resolution instructional illustration showing a hand blotting a red wine stain on a beige wool carpet with a white cloth. The bottle of sparkling water is visible next to the carpet. Style: simple, clear, and realistic,” and transmits these prompts to an image or video generative model. The output is explanation image data or explanation video data that visually represent one or more cleaning steps.

### Step 16:

Server composes an output data object associating steps, visuals, and item locations. The input is the emotion-adapted cleaning steps, the explanation image or video data, and the candidate items with provision location information. The server constructs a structured response in which each cleaning step is linked to textual descriptions, corresponding visuals, and any recommended items required for that step, along with store and aisle information. The output is a comprehensive output data object serialized for transmission to the terminal.

### Step 17:

Server transmits the output data object to the terminal via the communication interface. The input is the serialized response, and the server sends it over the network using a protocol such as HTTPS, optionally referencing media files stored on a content delivery system. The output is a delivered response payload received by the terminal.

### Step 18:

Terminal decodes the response and renders an interactive user interface on the display. The input is the response payload, and the terminal parses the structured data to reconstruct the list of cleaning steps, associated images or videos, and candidate item locations. The terminal creates visual components such as step cards, image thumbnails, play buttons, and store location labels. The output is an interactive display where the user can scroll through steps, view visuals, and access item details.

### Step 19:

Terminal optionally acquires position information of the user and requests navigation data. The input is sensor measurements from a location module such as GPS or an indoor positioning system. The terminal encodes the user's current position and sends it along with selected item identifiers to the server. The output is a location request message that references both user position and target item locations.

### Step 20:

Server computes route information and returns guidance instructions to the terminal. The input is the user's current position and the provision location information for target items. The server represents the store or environment as a graph and runs a pathfinding algorithm to determine an efficient route. The server then encodes the route as waypoints or stepwise guidance text. The output is guidance information that the terminal can display as a map route or augmented reality overlay.

### Step 21:

User follows the displayed cleaning procedure and navigation, and optionally provides feedback. The input is the guidance shown on the terminal, including steps and navigation. The user performs physical actions such as acquiring items and cleaning the stain, and may then capture “after” images or enter success ratings. The output is feedback data transmitted back to the server, which can be used by the server to update performance statistics and refine future prompt sentences and processing parameters.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

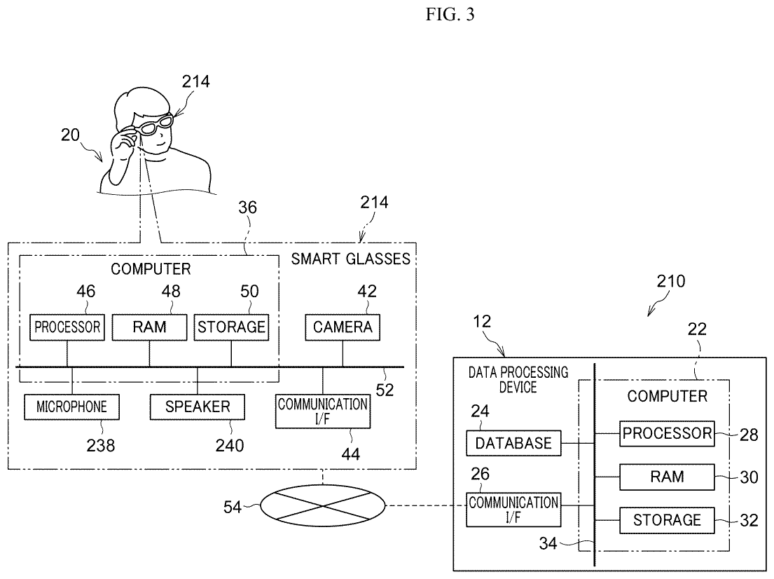

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

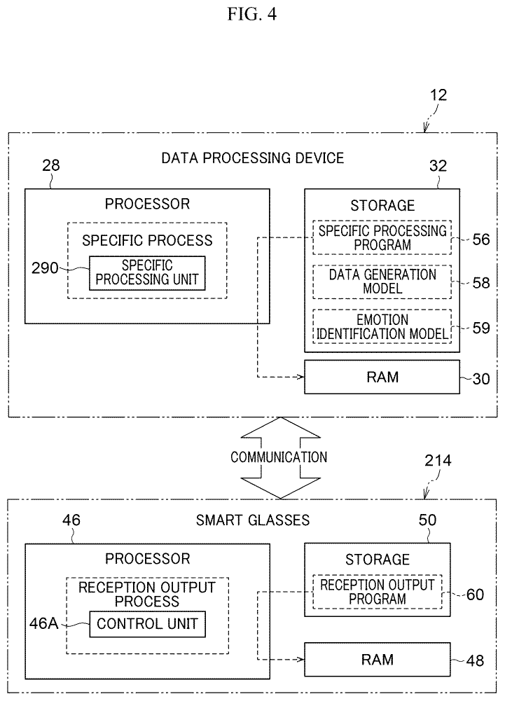

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

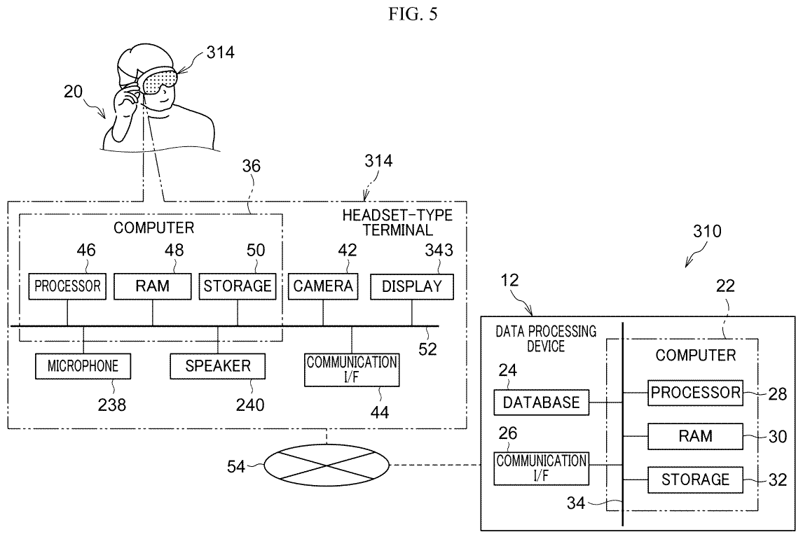

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

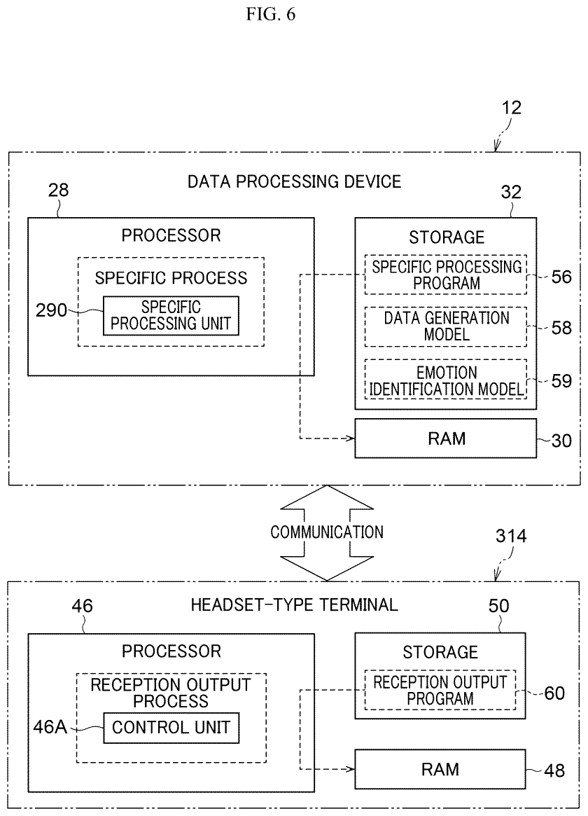

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

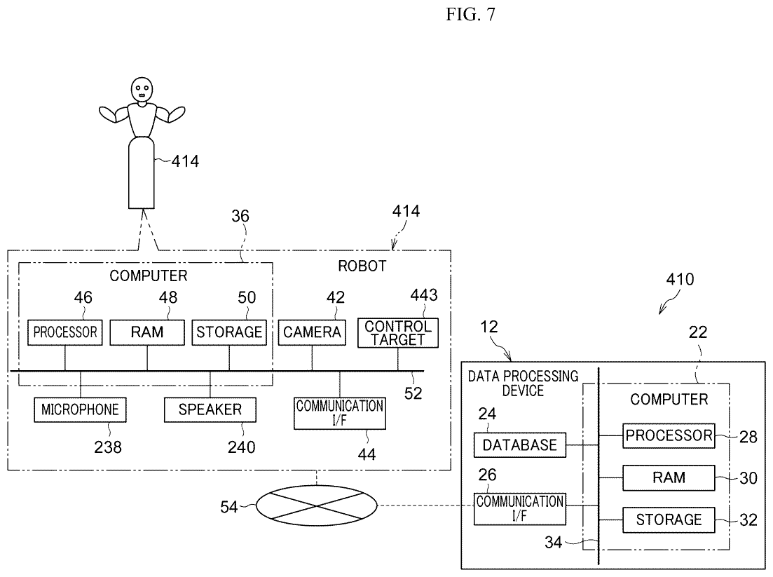

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

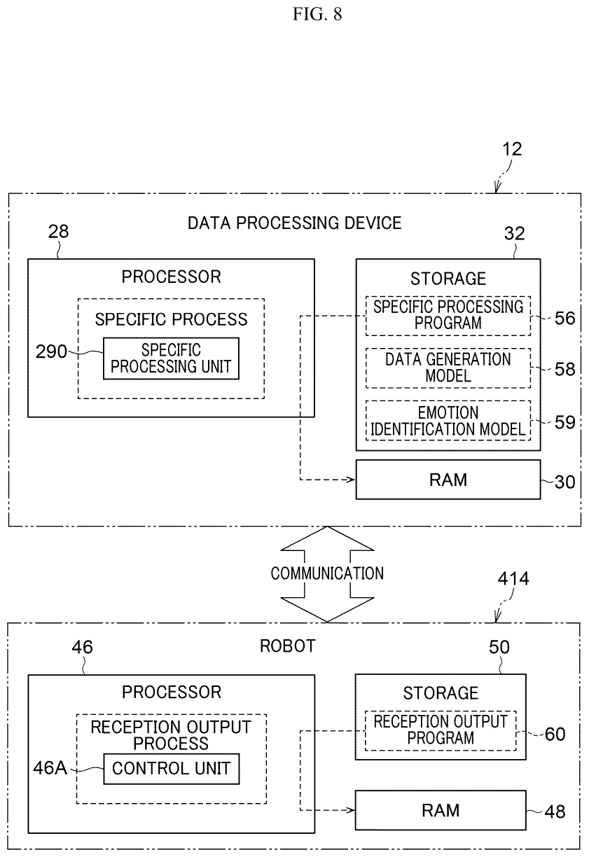

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

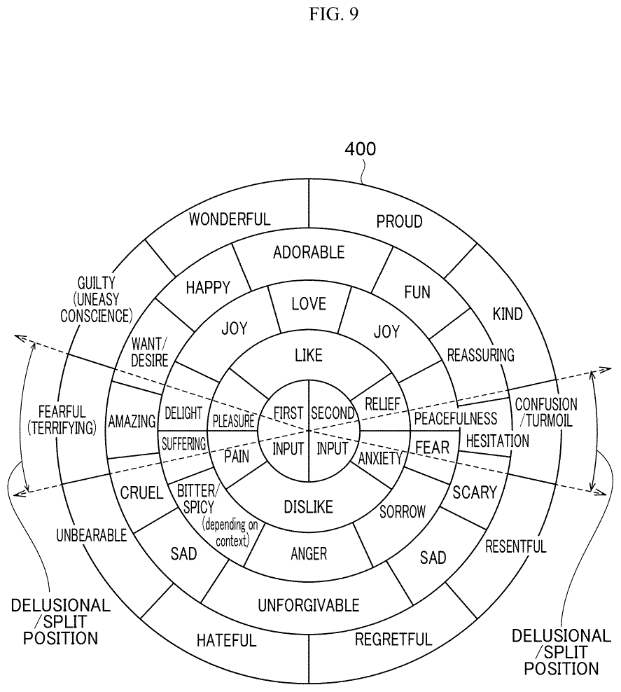

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

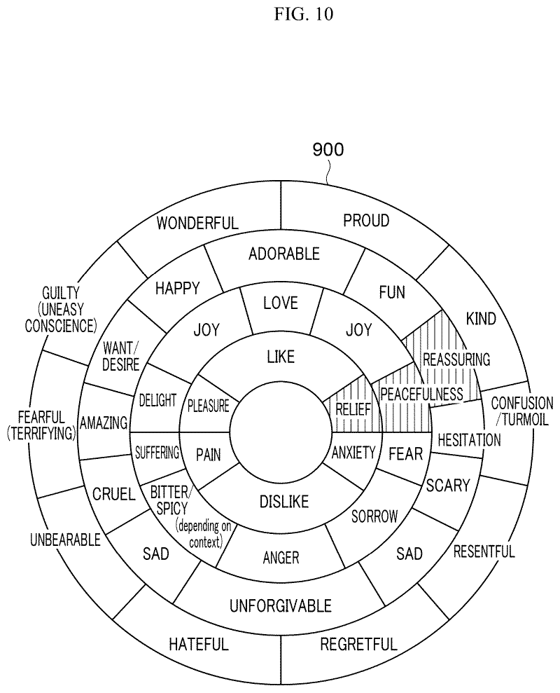

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire first image data including a soiled region, second image data including an entire object including the soiled region, material information, soil occurrence information, and elapsed-time information, and generate structured input data based on the first image data, the second image data, the material information, the soil occurrence information, and the elapsed-time information,
execute image analysis processing on the structured input data to estimate a soil type, a soil region, and soil characteristics, combine the soil characteristics with the material information and the elapsed-time information to generate a feature quantity, and generate a search condition based on the feature quantity for extracting cleaning-method information defining cleaning conditions and a cleaning procedure,
perform, based on the search condition, an inquiry process to an information storage unit that stores the cleaning-method information, acquire a plurality of candidate cleaning-method information items, evaluate the plurality of candidate cleaning-method information items based on material protection, cleaning effectiveness, and workability, and select an optimal candidate cleaning-method information item,
decompose the selected optimal candidate cleaning-method information item into elements, generate structured cleaning information including tool information, detergent information, liquid-condition information, procedure information, and caution information, generate a prompt sentence for instructing generation of an explanatory text describing an analysis result including the structured cleaning information, and input the prompt sentence to a generative AI model to cause the generative AI model to generate the explanatory text in natural language,
generate presentation output data by combining the explanatory text and the structured cleaning information such that document information, graphic information, image information, and video information are included, and transmit the presentation output data to a terminal device to visually present the presentation output data, and
estimate a user emotional state based on user operation information or sensor information acquired from the terminal device, and dynamically adjust at least one of content of the prompt sentence to the generative AI model and a configuration of the presentation output data such that at least one of a detail level, an expression style, and a presentation order of the explanatory text is changed according to the user emotional state.

### (Supplementary 2)

The system according to supplementary 1,
wherein the processor is configured to
cause acquisition of the first image data, the second image data, the material information, the soil occurrence information, and the elapsed-time information to be performed by using a portable terminal device or an image acquisition device having an imaging function, and by executing a user interface control program on the portable terminal device or the image acquisition device to perform acquisition of the first image data and the second image data and to receive manual input or selection input of the material information, the soil occurrence information, and the elapsed-time information.

### (Supplementary 3)

The system according to supplementary 1,
wherein the processor is configured to
generate the presentation output data such that, based on the structured cleaning information and the explanatory text obtained from the generative AI model, graphic information, image information, and video information associated with respective steps of the cleaning procedure are automatically selected or generated, and to output the graphic information, the image information, and the video information to the terminal device in a format that enables continuous or stepwise display so as to provide visual presentation that supports user understanding.

### Application Example 1

### (Supplementary 1)

A system comprising a processor,
wherein the processor is configured to
acquire, from an imaging device that images a target surface to which contamination adheres,
an image of a contaminated portion and an image of an entire target including the contamination, and further acquire material information of the target surface, history information regarding occurrence of the contamination, and elapsed-time information from adhesion of the contamination, perform image-size conversion and color-space conversion on the images to normalize the images, and perform smoothing processing, edge-enhancement processing, and region-extraction processing on the images to extract feature values corresponding to a contamination region,
input the extracted feature values and image data relating to the contamination region to a learned discrimination model, classify a type and a degree of the contamination, and integrate a classification result with the material information, the history information, and the elapsed-time information to generate structured data describing a contamination state,
assemble, based on the structured data, an explanatory text in a natural language including the contamination state, the material, safety conditions, and conditions of resources used for cleaning, generate a prompt sentence for a generative artificial intelligence model according to a template, and transmit the prompt sentence to the generative artificial intelligence model so as to cause the generative artificial intelligence model to generate cleaning-method information including cleaning steps and precautions corresponding to the contamination state,
search, based on contents of the cleaning-method information, an information storage device that stores cleaning-knowledge information in association with the type of contamination and the material, collate the cleaning-method information generated by the generative artificial intelligence model with the cleaning-knowledge information, and complement or modify the cleaning steps to select an optimized cleaning method and a list of necessary cleaning resources in accordance with the contamination state,
acquire, based on the list of necessary cleaning resources, information relating to suppliers that provide the cleaning resources from the information storage device or an external information providing device, and organize output data in which the cleaning resources are associated with the supplier information,
generate, based on the optimized cleaning method and the output data, at least one of a descriptive text, graphic information, still-image information, and moving-image information representing cleaning steps, generate visual content that explains cleaning operations by using the generative artificial intelligence model or an image-generation model, and output the visual content together with the cleaning resources and the supplier information to a user interface device,
analyze, based on input-operation information, biometric information, or browsing-behavior information acquired from the user interface device, an emotional state or a comprehension level of a user, and dynamically adjust an information-presentation format including a detail level of the descriptive text, a configuration of the graphic information, and an order and an amount of the still-image information or the moving-image information in accordance with an analysis result, and
generate, in response to an instruction from the user interface device, a sequence of control commands for a work device that automatically executes the cleaning method, the sequence of control commands including a movement path, an acting force, a number of processing repetitions, and a processing target region, transmit the sequence of control commands to the work device to cause the work device to execute a cleaning process, acquire, from the imaging device, an image after the cleaning process, re-analyze a residual state of the contamination region, determine necessity of additional cleaning based on a re-analysis result, and record the determination result and a cleaning history in the information storage device.

### (Supplementary 2)

The system according to supplementary 1,
wherein the processor is configured to
receive, via a communication network, image data acquired from an imaging device included in a work device provided with an imaging unit mounted on industrial equipment or an imaging device mounted on a portable information terminal, and automatically execute, by an image-processing program, preprocessing and feature-value extraction processing with respect to the image data.

### (Supplementary 3)

The system according to supplementary 1,
wherein the processor is configured to
create, based on the cleaning-method information output from the generative artificial intelligence model, a prompt sentence for generating visual content, input the prompt sentence to an image-generation model or a video-generation model to generate at least one of graphic information, still-image information, and moving-image information that sequentially illustrates a cleaning target surface, used resources, and work operations, and present, to the user interface device, the graphic information, the still-image information, or the moving-image information in association with respective steps of the cleaning method to assist understanding by a user.

### Example 2

### (Supplementary 1)

A system comprising a processor,
wherein the processor is configured to
acquire, from a user terminal, a text-based prompt sentence related to a contaminant and image information related to the contaminant, analyze the prompt sentence to identify a type of the contaminant, a material of an object to be cleaned, and a request content of a user, and analyze the image information to identify a region of the contaminant and a state of the contaminant,
generate, on the basis of an analysis result of the prompt sentence and an analysis result of the image information, an instruction prompt sentence including instruction content to be provided to a generative AI model, and use the generative AI model to generate explanatory text content including a cleaning procedure, a usage method of a tool, a usage method of a cleaning agent, and safety information,
generate, on the basis of the explanatory text content, an image-generation prompt sentence and a video-generation prompt sentence that respectively represent visual scenes corresponding to steps of the cleaning procedure, and use an image-generation generative AI model and a video-generation generative AI model to generate image content and video content that visually present the cleaning procedure,
generate output data in which the explanatory text content, the image content, and the video content are associated and structured, transmit the output data to the user terminal via a communication network, and control presentation such that, on the user terminal, the explanatory text content, the image content, and the video content are presented in association with respective steps of the cleaning procedure,
perform iterative processing in which, on the basis of an additional prompt sentence and updated image information acquired from the user terminal after execution of at least part of the cleaning procedure, a progress state of the cleaning procedure is evaluated and the cleaning procedure is updated stepwise by using the generative AI model again, and updated explanatory text content, updated image content, and updated video content are generated and transmitted to the user terminal, and
estimate a comprehension level and an emotional state of the user on the basis of operation-history information and reaction information acquired from the user terminal, and adjust an information-presentation method by dynamically changing at least one of an order, a detail level, and a representation form of the explanatory text content, the image content, and the video content.

### (Supplementary 2)

The system according to supplementary 1,
wherein the processor is configured to
cause the user terminal to acquire, by using an image-capturing function of an information-processing apparatus, a partial image of a region including the contaminant and an overall image of a region including the contaminant, and to transmit the partial image and the overall image as the image information to the system.

### (Supplementary 3)

The system according to supplementary 1,
wherein the processor is configured to
extract scene information indicating respective steps of the cleaning procedure from the explanatory text content and the image content, generate subtitle information, highlight information, and guide information on the basis of the scene information, and superimpose the subtitle information, the highlight information, and the guide information on the video content to present a visual solution method that facilitates understanding by the user.

### Application Example 2

### (Supplementary 1)

A system comprising a processor, a memory, a storage device, a communication interface,
and a display device,
wherein the processor is configured to
acquire, via an input device or the communication interface, first image data indicating a region to which a stain is attached, second image data indicating an entire object including the stain, material information of the object, situation information indicating how the stain occurred, and elapsed time information indicating a time elapsed since the stain occurred; and
execute an image processing program on the first image data and the second image data to perform at least one of preprocessing, region extraction, feature extraction, and classification processing of a stain type, and generate structured information regarding the stain by integrating a result of the classification processing with the material information, the situation information, and the elapsed time information; and
generate, based on the structured information, a prompt sentence including an instruction sentence to be input to a generative artificial intelligence model, and transmit the prompt sentence to the generative artificial intelligence model via the communication interface to obtain cleaning method information including cleaning procedure information and item usage information from the generative artificial intelligence model; and
analyze the cleaning method information obtained from the generative artificial intelligence model to extract item information indicating cleaning tools and chemical agents required for a cleaning operation, and, based on the item information, search an item information storage device to retrieve candidate items and provision location information of the candidate items; and
execute, based on at least one of voice information, image information, and text information related to a user, an emotion estimation process using an emotion estimation program to estimate an emotional state of the user, and change at least one of a detail level of the cleaning method information, a presentation style of the cleaning method information, and a presentation priority of the candidate items in accordance with the emotional state; and
generate, using at least one of the generative artificial intelligence model and an image processing program, explanation image data, explanation video data, or explanation graphic data associated with the cleaning method information and the candidate items and the provision location information, and construct output data in which respective steps of the cleaning procedure information are associated with corresponding ones of the explanation image data, the explanation video data, or the explanation graphic data; and
control, via the communication interface, a terminal device including the display device so as to cause the terminal device to receive the output data and interactively display, on the display device, text information of the cleaning procedure, the explanation image data, the explanation video data, or the explanation graphic data corresponding to the text information, and the provision location information of the candidate items.

### (Supplementary 2)

The system according to supplementary 1,
wherein the processor is configured to obtain position information of the user from the terminal device via the communication interface, calculate route information from a current position of the user to a provision location of at least one of the candidate items based on the position information and the provision location information, and cause the terminal device to display guidance information based on the route information on at least one of the display device and an augmented-reality display device.

### (Supplementary 3)

The system according to supplementary 1,
wherein the processor is configured to generate, based on the structured information and the emotional state, a plurality of different prompt sentences including at least a prompt sentence for generating the cleaning method information, a prompt sentence for generating simplified explanation information, and a prompt sentence for designing visual content, and selectively transmit the plurality of different prompt sentences to the generative artificial intelligence model so that a plurality of types of explanation information corresponding to a state of the user are generated.

What is claimed is:

1. A system comprising:
circuitry configured to:
receive, via a communication interface coupled to a packet-switched network, first image data including a region of interest, second image data including an entire object incorporating the region of interest, material information, occurrence information, and elapsed-time information from a terminal device, and convert the received data into structured input data;
execute image analysis processing on the structured input data to estimate a region type, region characteristics, and affected area parameters, and combine the region characteristics with the material information and the elapsed-time information to generate a feature quantity;
generate, based on the feature quantity, a search condition for retrieving method information defining processing conditions and a processing procedure, perform an inquiry process to a storage device using the search condition to obtain a plurality of candidate method information items, and evaluate the plurality of candidate method information items based on at least material compatibility, processing effectiveness, and operability to select an optimal candidate;
generate a prompt sentence for instructing a generative AI model to generate processing guidance content based on the feature quantity and the selected optimal candidate, and transmit the prompt sentence to the generative AI model to obtain guidance content data; and
receive user state data from the terminal device, apply an emotion recognition model to the user state data to generate an emotional state representation, adjust a presentation format of the guidance content data based on the emotional state representation, and transmit the adjusted guidance content data to the terminal device via the communication interface.

2. The system according to claim 1, wherein the circuitry is configured to
apply a convolutional neural network to the first image data and the second image data to extract visual feature vectors representing the region characteristics and the material properties, and use the visual feature vectors as inputs to the feature quantity generation.

3. The system according to claim 2, wherein the circuitry is configured to
apply a region segmentation model to the first image data to identify a boundary of the region of interest, estimate an area proportion of the region of interest relative to the entire object, and incorporate the area proportion as a parameter in the feature quantity.

4. The system according to claim 3, wherein the circuitry is configured to
apply a material classification model to the second image data to identify material type features independent of the material information received from the terminal device, and use the identified material type features to validate the material information.

5. The system according to claim 4, wherein the circuitry is configured to
apply a time-decay function to the elapsed-time information to generate a time-weighted degradation parameter, and incorporate the time-weighted degradation parameter in the feature quantity to adjust candidate method information evaluation scores.

6. The system according to claim 1, wherein the circuitry is configured to
generate the guidance content data comprising at least one of text instructions, diagram data, image data, and video data using the generative AI model, and transmit the guidance content data to the terminal device for visual presentation.

7. The system according to claim 6, wherein the circuitry is configured to
apply a multimodal generation model to generate synchronized text and visual guidance content data, and assemble the text and visual components into a structured presentation format for transmission to the terminal device.

8. The system according to claim 1, wherein the circuitry is configured to
evaluate the plurality of candidate method information items using a multi-criteria scoring function that assigns weighted scores to material compatibility, processing effectiveness, and operability parameters, and select the candidate with the highest aggregate score as the optimal candidate.

9. The system according to claim 8, wherein the circuitry is configured to
apply a ranking model to re-rank the plurality of candidate method information items based on user preference information stored in the storage device, and present re-ranked candidates to the user via the terminal device prior to final selection.

10. The system according to claim 1, wherein the circuitry is configured to
apply facial expression recognition processing to image data included in the user state data to classify the emotional state into predefined categories, and apply voice analysis processing to audio data included in the user state data to generate prosodic features, and combine the facial expression classification and the prosodic features in the emotion recognition model.

11. The system according to claim 10, wherein the circuitry is configured to
adjust the presentation format of the guidance content data by selecting a simplified instruction format when a high-stress emotional state is detected and a detailed technical format when a calm emotional state is detected.

12. The system according to claim 1, wherein the circuitry is configured to
receive the first image data and the second image data from an image acquisition device coupled to the terminal device, apply an image quality assessment model to verify that the first image data and the second image data satisfy minimum resolution and focus quality requirements, and request re-capture when the quality requirements are not met.

13. The system according to claim 12, wherein the circuitry is configured to
apply an image preprocessing pipeline to the first image data and the second image data comprising color normalization, contrast enhancement, and noise reduction prior to executing the image analysis processing.

14. The system according to claim 1, wherein the circuitry is configured to
store the structured input data, the feature quantity, and the selected optimal candidate in the storage device indexed by region type and material information, and use stored historical data to improve candidate evaluation scoring over time.

15. The system according to claim 14, wherein the circuitry is configured to
receive outcome feedback information from the terminal device indicating a result of applying the guidance content data, and update the candidate evaluation scoring parameters based on the outcome feedback information.

16. The system according to claim 1, wherein the circuitry is configured to
apply a natural language processing model to the occurrence information received from the terminal device to extract circumstance parameters and temporal context, and incorporate the circumstance parameters and temporal context as additional fields in the structured input data.

17. The system according to claim 16, wherein the circuitry is configured to
apply a context classification model to the circumstance parameters to assign an occurrence category, and use the occurrence category as an additional search parameter in the search condition for retrieving candidate method information items.

18. A system comprising:
circuitry configured to:
receive, via a communication interface coupled to a packet-switched network, first image data including a region of interest, second image data including an entire object, material information, occurrence information, and elapsed-time information from a terminal device;
apply a convolutional neural network to the first image data and the second image data to extract visual feature vectors, apply a region segmentation model to identify a boundary of the region of interest, apply a time-decay function to the elapsed-time information to generate a time-weighted degradation parameter, and combine the visual feature vectors, material information, and time-weighted degradation parameter to generate a feature quantity;
generate search conditions from the feature quantity, retrieve a plurality of candidate method information items from a storage device, apply a multi-criteria scoring function to evaluate the candidates, and select an optimal candidate based on evaluation scores;
generate a prompt sentence incorporating the feature quantity and the selected optimal candidate, input the prompt sentence to a generative AI model to obtain guidance content data comprising text, diagram, and image components; and
apply an emotion recognition model to user state data received from the terminal device to generate an emotional state representation, adjust a presentation format of the guidance content data based on the emotional state representation, and transmit the adjusted guidance content data to the terminal device.

19. The system according to claim 18, wherein the circuitry is configured to
receive outcome feedback information from the terminal device indicating a result of applying the guidance content data, update candidate evaluation scoring parameters in the storage device based on the outcome feedback information, and apply updated scoring parameters in subsequent candidate method information evaluation.

20. A method comprising:
receiving, via a communication interface coupled to a packet-switched network, first image data including a region of interest, second image data including an entire object incorporating the region of interest, material information, occurrence information, and elapsed-time information from a terminal device, and converting the received data into structured input data;
executing image analysis processing on the structured input data to estimate a region type, region characteristics, and affected area parameters, and combining the region characteristics with the material information and the elapsed-time information to generate a feature quantity;
generating, based on the feature quantity, a search condition for retrieving method information defining processing conditions and a processing procedure, performing an inquiry process to a storage device using the search condition to obtain a plurality of candidate method information items, and evaluating the plurality of candidate method information items to select an optimal candidate;
generating a prompt sentence for instructing a generative AI model to generate processing guidance content based on the feature quantity and the selected optimal candidate, and transmitting the prompt sentence to the generative AI model to obtain guidance content data; and
receiving user state data from the terminal device, applying an emotion recognition model to the user state data to generate an emotional state representation, adjusting a presentation format of the guidance content data based on the emotional state representation, and transmitting the adjusted guidance content data to the terminal device via the communication interface.
